(19) United States
(12) Patent Application Publication
(10) Pub. No.: US 2024/0346605 A1
(43) Pub. Date: Oct. 17, 2024

(54) CROP GROWTH ASSISTANCE APPARATUS, CROP GROWTH ASSISTANCE METHOD, AND RECORDING MEDIUM

(71) Applicant: NEC Corporation, Minato-ku, Tokyo (JP)

(72) Inventors: Yoji Mori, Tokyo (JP); Ayako Hoshino, Tokyo (JP); Yuya Endo, Tokyo (JP); Yuuki Watanabe, Tokyo (JP); Naruto Yajima, Tokyo (JP)

(73) Assignee: NEC Corporation, Minato-ku, Tokyo (JP)

(21) Appl. No.: 18/682,480

(22) PCT Filed: Sep. 15, 2021
(86) PCT No.: PCT/JP2021/033832

§ 371 Date: Feb. 9, 2024

(51) Int. Cl. G06Q 50/02; A01G 7/00

(52) U.S. Cl. CPC G06Q 50/02; A01G 7/00

(57) ABSTRACT

In order for the growth of a crop to be assisted, a crop growth assistance apparatus (1) includes an accepting section (11) for accepting a request containing any of a size, a taste, a harvest period, and a harvest yield of a crop which is a subject of growth; a generating section (12) for generating response information containing a method for growing the crop which is the subject of growth, in accordance with the request and a learned model having learned relations between methods for growing a plurality of crops and growth results including any of sizes, tastes, harvest periods, and harvest yields of the plurality of crops; and an outputting section (13) for outputting the method for growing the crop which is the subject of growth.

### TECHNICAL FIELD

The present invention relates to a crop growth assistance apparatus, etc. which generate information regarding the growth of a crop.

### BACKGROUND ART

In growing a crop, a wide variety of tasks are required, and the details, a timing, etc. of each of the tasks affects the growth result. Typically, the determination of such details and timing of a task are made while relying on experience and intuition. Further, as disclosed in Patent Literature 1, a technique for using a sensor to acquire information on management of the growth of a plant has been known.

### CITATION LIST

### Patent Literature

### [Patent Literature 1]

Japanese Patent Application Publication, Tokukai, No. 2017-184678

### SUMMARY OF INVENTION

### Technical Problem

However, in some cases, a stable growth result cannot be obtained by experience and intuition, and it is not easy to transfer the experience and intuition to a new grower. In addition, even when a growth state can be grasped via a sensor, it is not easy to determine proper details of a task according to the growth state. Therefore, there is the demand for a technique for assisting the growth of a crop, so as to enable an experienced grower to more stably grow a crop, or enable even a less-experienced grower to appropriately grow a crop.

An example aspect of the present invention has been made in view of the above problems, and an example object thereof is to provide a technique for assisting the growth of a crop.

### Solution to Problem

A crop growth assistance apparatus in accordance with an example aspect of the present invention includes: an accepting means for accepting a request containing any of a size, a taste, a harvest period, and a harvest yield of a crop which is a subject of growth; a generating means for generating response information containing a method for growing the crop which is the subject of growth, in accordance with the request and a learned model having learned relations between methods for growing a plurality of crops and growth results including any of sizes, tastes, harvest periods, and harvest yields of the plurality of crops; and an outputting means for outputting the method for growing the crop which is the subject of growth.

A crop growth assistance method in accordance with an example aspect of the present invention includes: a computer accepting a request containing any of a size, a taste, a harvest period, and a harvest yield of a crop which is a subject of growth; the computer generating response information containing a method for growing the crop which is the subject of growth, in accordance with the request and a learned model having learned relations between methods for growing a plurality of crops and growth results including any of sizes, tastes, harvest periods, and harvest yields of the plurality of crops; and the computer outputting the method for the crop which is growing the subject of growth.

A crop growth assistance program in accordance with an example aspect of the present invention causes a computer to carry out: a process of accepting a request containing any of a size, a taste, a harvest period, and a harvest yield of a crop which is a subject of growth; a process of generating response information containing a method for growing the crop which is the subject of growth, in accordance with the request and a learned model having learned relations between methods for growing a plurality of crops and growth results including any of sizes, tastes, harvest periods, and harvest yields of the plurality of crops; and a process of outputting the method for growing the crop which is the subject of growth.

### Advantageous Effects of Invention

An example aspect of the present invention makes it possible to assist the growth of animals and plants.

### BRIEF DESCRIPTION OF DRAWINGS

FIG. 1 is a block diagram illustrating a configuration of a crop growth assistance apparatus in accordance with a first example embodiment of the present invention.

FIG. 2 is a flowchart illustrating a flow of a crop growth assistance method in accordance with a first example embodiment of the present invention.

FIG. 3 is an explanatory diagram of learning of a feature quantity in graph-based relationship learning.

FIG. 4 is a diagram illustrating an outline of a crop growth assistance method in accordance with a second example embodiment of the present invention.

FIG. 5 is a block diagram illustrating a configuration of a crop growth assistance apparatus in accordance with the second example embodiment of the present invention.

FIG. 6 is a flowchart illustrating a flow of a process carried out by the crop growth assistance apparatus in accordance with the second example embodiment of the present invention.

FIG. 7 is a diagram illustrating an example of response information.

FIG. 8 is a diagram illustrating an outline of a crop growth assistance method in accordance with a third example embodiment of the present invention.

FIG. 9 is a block diagram illustrating a configuration of a crop growth assistance apparatus in accordance with the third example embodiment of the present invention.

FIG. 10 is a flowchart illustrating a flow of a process carried out by the crop growth assistance apparatus in accordance with the third example embodiment of the present invention.

FIG. 11 is a diagram illustrating an outline of a crop growth assistance method in accordance with a fourth example embodiment of the present invention.

FIG. 12 is a block diagram illustrating a configuration of a crop growth assistance apparatus in accordance with the fourth example embodiment of the present invention.

FIG. 13 is a flowchart illustrating a flow of a process carried out by the crop growth assistance apparatus in accordance with the fourth example embodiment of the present invention.

FIG. 14 is a diagram illustrating an outline of a crop growth assistance method in accordance with a fifth example embodiment of the present invention.

FIG. 15 is a block diagram illustrating a configuration of a crop growth assistance apparatus in accordance with the fifth example embodiment of the present invention.

FIG. 16 is a flowchart illustrating a flow of a process carried out by the crop growth assistance apparatus in accordance with the fifth example embodiment of the present invention.

FIG. 17 is an explanatory diagram of an example in which the result of growing the subject of growth is predicted in accordance with feature quantities calculated from a to-be-grown graph and a grown graph.

FIG. 18 is a diagram of a configuration for providing the crop growth assistance apparatuses by software.

### EXAMPLE EMBODIMENTS

### First Example Embodiment

The following description will discuss a first example embodiment of the present invention in detail, with reference to the drawings. The present example embodiment is basic to example embodiments which will be described later.

### (Crop Growth Assistance Apparatus)

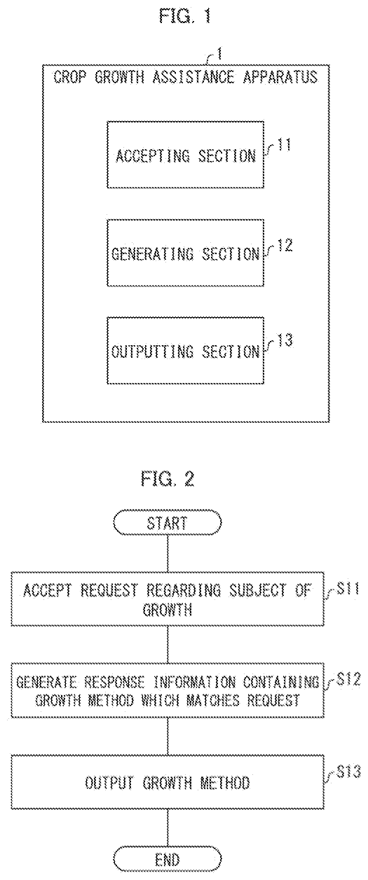

A configuration of a crop growth assistance apparatus 1 in accordance with the present example embodiment will be described below with reference to FIG. 1. FIG. 1 is a block diagram illustrating a configuration of the crop growth assistance apparatus 1. The crop growth assistance apparatus 1 includes an accepting section (accepting means) 11, a generating section (generating means) 12, and an outputting section (outputting means) 13, as illustrated.

The accepting section 11 accepts a request containing any of the size, the taste, the harvest period, and the harvest yield of a crop which is the subject of growth. The generating section 12 generates response information containing a method for growing the crop which is the subject of growth, in accordance with the request and a learned model having learned relations between methods for growing a plurality of crops and growth results including any of the sizes, the tastes, the harvest periods, and the harvest yields of the plurality of crops. The outputting section 13 outputs the response information.

With the crop growth assistance apparatus 1 having the above configuration, a request regarding a crop which is the subject of growth is accepted. Further, response information containing a method for growing the crop which is the subject of growth is generated, in accordance with the request and a learned model having learned relations between methods for growing a plurality of crops and growth results including any of the sizes, the tastes, the harvest periods, and the harvest yields of the plurality of crops.

This makes it possible to generate response information useful for growing the crop which is the subject of growth, in view of various kinds of information regarding previously grown crops. Thus, the above configuration provides an example advantage of making it possible to assist the growth of a crop.

### (Program)

The functions of the crop growth assistance apparatus 1 can be implemented through a program. A program in accordance with the present example embodiment causes a computer to carry out a process of accepting a request containing any of the size, the taste, the harvest period, and the harvest yield of a crop which is the subject of growth; a process of generating response information containing a method for growing the crop which is the subject of growth, in accordance with the request and a learned model having learned relations between methods for growing a plurality of crops and growth results including any of the sizes, the tastes, the harvest periods, and the harvest yields of the plurality of crops; and a process of outputting the method for growing the crop which is the subject of growth. This program provides an example advantage of making it possible to assist the growth of a crop.

### (Crop Growth Assistance Method)

A crop growth assistance method in accordance with the present example embodiment will be described below with reference to FIG. 2. FIG. 2 is a flowchart illustrating a flow of a crop growth assistance method in accordance with the first example embodiment of the present invention.

In S11, a computer accepts a request containing any of the size, the taste, the harvest period, and the harvest yield of a crop which is the subject of growth. The request may be accepted via any input equipment. For example, the request may be accepted via a mouse, a keyboard, a touch panel, or voice-input equipment.

In S12, the computer generates response information containing a method for growing the crop which is the subject of growth, in accordance with the request and a learned model having learned relations between methods for growing a plurality of crops and growth results including any of the sizes, the tastes, the harvest periods, and the harvest yields of the plurality of crops.

In S13, the computer outputs the response information generated in S12. The response information is outputted to any equipment. For example, the information may be outputted to a display so as to be outputted on a display basis, or may be outputted to voice-output equipment so as to be outputted on a voice basis.

As above, with the crop growth assistance method in accordance with the present example embodiment, a computer accepts a request containing any of the size, the taste, the harvest period, and the harvest yield of a crop which is the subject of growth (S11), the computer generates response information containing a method for growing the crop which is the subject of growth, in accordance with the request accepted in S11 and a learned model having learned relations between methods for growing a plurality of crops and growth results including any of the sizes, the tastes, the harvest periods, and the harvest yields of the plurality of crops (S12), and the computer outputs the response information generated in S12. This crop growth assistance method provides an example advantage of making it possible to assist the growth of a crop.

The steps of the crop growth assistance method may be carried out by a single computer (e.g., crop growth assistance apparatus 1), or may be carried out by respective computers. The same applies to flows which will be described in second and subsequent example embodiments.

### [Graph and Learning]

Here is a description of a graph which is an example of information which can be used to assist the growth of a crop in the first example embodiment and example embodiments which will be described later (hereinafter, referred to as each example embodiment). In addition, the training of the graph and prediction made with use of the graph will be described as well.

### (Graph)

The graph herein refers to data having a structure including a plurality of nodes and links connecting the nodes. The type of a link which represents a relation between nodes is referred to as a “relation”. Further, a link can be referred to as an edge. The graph roughly includes a directed graph in which each link has directionality, and an undirected graph in which each link has no directionality. It is possible to use either the directed graph or the undirected graph. It is also possible to use those graphs in combination.

In a case where the graph is used in each example embodiment, the nodes may represent tangible or intangible elements regarding a crop which is the subject of growth or a grown crop. For example, the graph containing nodes representing various elements such as:
crop identification information (e.g., the crop name, ID, variety, etc.);
growth state;
growth environment;
the type or details of a task; and
harvest period or harvest yield
   can be used. In this respect, the growth state can include, but not limited to, the state (color, size, shape) of leaves, the state (color, size, shape) of fruits, etc. For some crops, the growth state can also include the quality (flavor, taste (sugar content and acid taste)), etc. of the crops. The growth environment can include, but not limited to, atmospheric temperature (room temperature for plastic greenhouse culture), humidity, solar radiation intensity, etc.

The type and details of a task can include, for example, not only application of fertilizer, watering, intertillage, fruit thinning, etc. but also the amount of fertilizer applied, the timing of applying fertilizer, the frequency of watering, etc. The type and details of a task can also include an operation of adjusting solar radiation intensity, control of sunshine hours, control of room temperature, and control of humidity, etc. Such a task forms a part of the growth method.

The graph may contain a plurality of nodes which correspond to a single element. For example, a node indicating the growth environment of a crop may be represented by two independent nodes (e.g., “high temperature” and “high humidity”). The same applies to any other elements.

In a case where there is the above-described nodes serving as an element, a relation represented by a link includes:
a relation between a certain element and a growth state;
a relation between a certain element and a growth environment;
a relation between a certain element and the type and details of a task; and the like.
   For example, the link connecting a node indicating a growth environment and a node indicating a growth state may represent a relation in which the growth environment is a cause of the growth state.

As an example, the graph in each example embodiment may be a graph having a hierarchical structure, such as:
a graph containing a crop ID node which indicates a crop ID and a node which is connected to the crop ID node and which indicates a growth state and a growth environment; and
a task ID node indicating a task ID, a crop ID node which is connected to the task ID node, and a node which is connected to the task ID node and which indicates the details of various tasks. However, each example embodiment is not limited to these examples.

The harvest period described above and the period in which various tasks are performed may or may not be represented by a single node. For example, the harvest period may be hierarchically expressed by a plurality of nodes which indicate a task and fruit thinning, and links which connect these nodes and which indicate a temporal relation between the nodes. The harvest yield may also be hierarchically expressed by, for example, using a node and a link which indicate a first harvest yield at a first timing and a node and a link which indicate a second harvest yield at a second timing.

### (Learning and Prediction)

A machine learning technique can be used to perform graph-based relationship learning on the graph as described above. Performing such learning makes it possible to use the graph to carry out processes such as a classifying process and a predicting process. Note that in each example embodiment, such learning may be performed as a part of crop growth assistance, or a trained graph which already has undergone such learning may be used.

In graph-based relationship learning, the feature quantity of each node is calculated first. The feature quantity may be in, for example, a vector form. By representing the feature quantity of each node via a feature quantity vector, it is possible to also train a graph containing nodes of different forms in a mixed manner. For example, it is also possible to subject, to graph-based relationship learning, a graph containing images, numerical values, etc. which indicate various elements as described above.

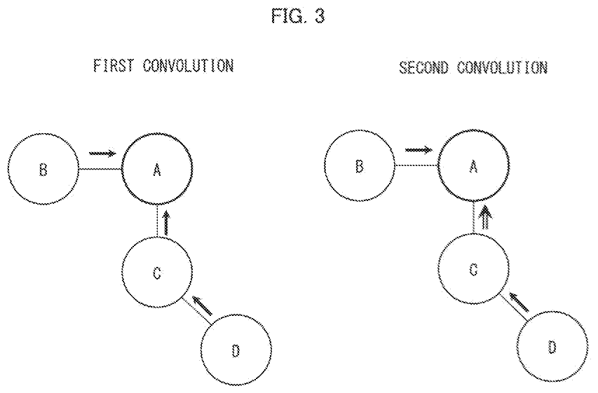

Next, the feature quantity of each node is updated in accordance with a link connected to each node and a node to which the link is connected. This process is similar to a convolution process in a convolutional neural network. This will be described below with reference to FIG. 3. FIG. 3 is an explanatory diagram illustrating learning of a feature quantity in graph-based relationship learning.

The graphs illustrated in FIG. 3 each contain four nodes A to D. The nodes B and C are connected to the node A, and the node D is connected to the node C. After calculating initial feature quantities of these four nodes, convolution is performed a plurality of times as described below to update the feature quantities of the respective nodes.

In the first convolution, the feature quantities of the nodes B and C connected to the node A are each multiplied by a predetermined weight and are then added to the initial feature quantity of the node A. For the node C, the feature quantity of the node D is multiplied by a predetermined weight and is then added to the initial feature quantity of the node C. Note that, in a case of a directed graph, the weight is adjusted according to the direction of the link.

In the second convolution, similarly to the first convolution, for each of the nodes, the feature quantity of a node linked to that node is multiplied by a predetermined weight, and is then added to the feature quantity of that node. In this respect, the feature quantity of the node D is reflected in the feature quantity of the node C by the first convolution. Therefore, by the second convolution, not only the feature quantity of the node C but also the feature quantity of the node D are reflected in the feature quantity of the node A.

By repeating the above-described process a number of times according to the hierarchy of nodes, the feature quantities of nodes which are directly or indirectly connected to each other via links are mutually reflected. In graph-based relationship learning, a weight value used for the above-described weighting is optimized on the basis of a known relationship between nodes. By using such a trained graph (which can also be referred to as a learned model), it is possible to make predictions such as an inter-node relation prediction and a link destination node prediction which are described below.

### (Inter-Node Relation Prediction)

By performing the learning described above, it is possible to predict an inter-node relation which is not explicitly indicated in an original graph. In a case of making an inter-node relation prediction, a user may designate two nodes and make a request for returning a relation between those nodes. For example, in a case where a request inquiring about a relation between a node of “crop A” and a node of “crop B” is inputted from a user, it is possible to predict, by inter-node relation prediction, whether a relation (i.e., a link) that connects these nodes is “similarity”. In the inter-node relation prediction, it is possible to calculate a probability (likelihood) of a prediction result. The same applies to a node prediction described below.

### (Node Prediction)

By performing the above-described learning, it is also possible to predict a node that is connected to a certain node via a predetermined link. In a case of making a node prediction, a user may designate one node and a link the starting point of which is the one node, and make a request for returning a node to which the link is connected. Assume, for example, that a request inquiring about a node connected to a node of “task history” via a link of “September”, i.e., a request inquiring a task to be carried out in September, is inputted from a user. In this case, it is possible to predict, for example, whether a node connected to the node of “task history” via the link of “September”, i.e., a task to be carried out in September, is a “task a3” or a “task a4”, by node prediction.

### Second Example Embodiment

### (Outline)

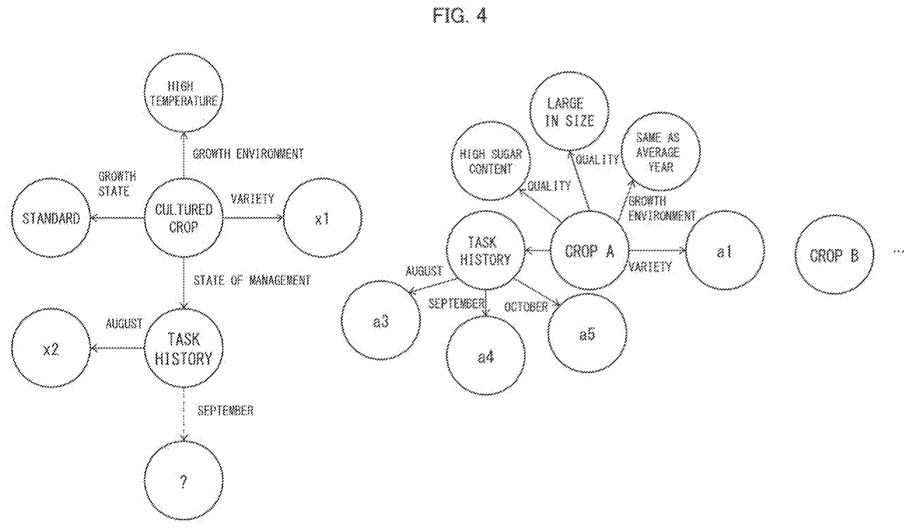

FIG. 4 is a diagram illustrating an outline of a crop growth assistance method in accordance with the present example embodiment. According to the present example embodiment, an example in which crop growth is assisted with use of a to-be-grown graph and a grown graph will be described.

The grown graph contains a plurality of nodes regarding a previously grown crop and links each indicating relationship between the corresponding nodes of the plurality of nodes. The grown graph is a graph having learned the relationship between nodes of the plurality of nodes, and is a learned model. The grown graph can be referred to as a knowledge graph. Note that a set of nodes and links corresponding to growth performed one time may be referred to as a grown graph, or sets of nodes and links corresponding to growth performed a plurality of times may be collectively referred to as a grown graph.

For example, the graph containing a node of “crop A” in FIG. 4 is the grown graph. The grown graph of the crop A contains the nodes and links which indicate that the quality of harvested products at the time of growing the crop A, which is a previously grown crop, are “high sugar content” and “large size”. The grown graph of the crop A also contains the nodes and links which indicate that the growth environment at the time of growth was “the same as an average year” and the variety of the crop A is “a1”. Further, the grown graph of the crop A contains the nodes and links which indicate the respective task histories of August to October for the crop A.

Note that “a1” indicates the variety name, and “a3” to “a5” indicate tasks. The “task” can contain the type and details of a task. As described above, for example, application of fertilizer, watering, intertillage, fruit thinning, etc. fall under the category of the “task”, and furthermore, the details of a task such as the amount of fertilizer applied, the timing of applying fertilizer, the frequency of watering, etc. fall under the category of the “task”. Such a task forms a part of the growth method.

With learning of a relation between the growth method and the growth result of the crop A, it is possible to generate such a grown graph. Furthermore, as is the case with the crop A, a grown graph containing nodes and links which are related to the growth method and the growth result of the crop B is generated, although the illustration thereof is omitted in FIG. 4. In this manner, a plurality of grown graphs are generated in advance.

The growth state and the growth environment may be represented with use of differences from preset reference states. For example, a difference or ratio between the total number of leaves of a crop in a certain growth period and the standard total number of leaves for the period may be set for a node, as information which indicates the growth state of the crop in the period. In addition, on the basis of the difference or ratio thus calculated, a growth state may be classified as good, normal, poor, etc., and the classifications may be represented with use of nodes. Regarding the growth environment, a difference or ratio between the amount of sunlight in a certain growth period of a crop and the standard amount of sunlight for the period may be set for a node, as information which indicates the growth environment in the period. In addition, on the basis of the difference or ratio thus calculated, a growth environment may be classified as dry, the same as an average year, moist, etc., and the classifications may be represented with use of nodes.

The to-be-grown graph is a graph containing a plurality of nodes regarding a cultured crop which is the subject of growth. Note that the cultured crop may be a crop which is to be cultured in the future, or may be a crop under cultivation. In FIG. 4, the graph containing a node “cultured crop” is the to-be-grown graph. This to-be-grown graph contains the nodes and links which indicate that the growth state, growth environment, and variety of the cultured crop so far are “standard”, “high temperature”, and “x1”, respectively, and the node and link which indicate that the task history of the cultured crop in August is “x2”. Such a to-be-grown graph can be generated by, for example, accepting the input of necessary information from a grower or the like of the cultured crop.

By using the grown graph and the to-be-grown graph as described above, it is possible to make a link prediction of what growth method is suitable for the cultured crop. That is, with the crop growth assistance method in accordance with the present example embodiment, the method for growing a cultured crop is predicted by a link prediction, and the response information is generated in accordance with the prediction result and then outputted.

For example, in the example of FIG. 4, a link prediction may be made to predict which node, among various nodes which are contained in the grown graph and which indicate the details of a task, is likely to be connected via a link to a node contained in the to-be-grown graph (more specifically, the node of “September” linked to the “task history”). Subsequently, response information which indicates that the predicted task is a growth method suitable for the cultured crop may be generated and outputted.

### (Configuration of Apparatus)

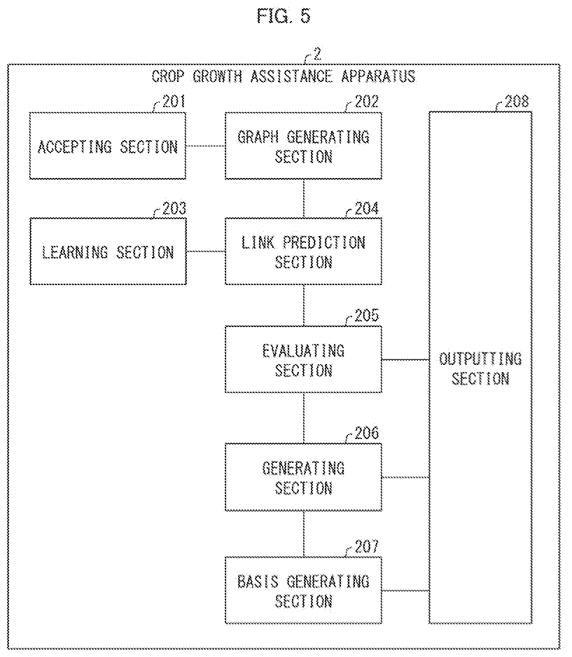

A configuration of a crop growth assistance apparatus 2 in accordance with the second example embodiment of the present invention will be described below on the basis of FIG. 5. FIG. 5 is a block diagram illustrating a configuration of the crop growth assistance apparatus 2 of the present example embodiment.

The crop growth assistance apparatus 2 includes an accepting section 201, a graph generating section 202, a learning section 203, a link prediction section 204, an evaluating section 205, a generating section 206, a basis generating section 207, and an outputting section 208, as illustrated.

In addition to these components, the crop growth assistance apparatus 2 may include, for example, input equipment via which to accept an input operation of a user, output equipment via which the crop growth assistance apparatus 2 outputs data, and communication equipment via which the crop growth assistance apparatus 2 communicates with another apparatus. The output from the output equipment may be in any manner, and may be outputted, for example, on a display basis or on a voice basis.

The accepting section 201 accepts a request regarding a crop which is the subject of growth (corresponding to the cultured crop described above, and can be referred to simply as the subject of growth in short). For example, the accepting section 201 accepts a request containing any of the size, the taste, the harvest period, and the harvest yield of the subject of growth (more precisely, a harvested product obtained by growing the subject of growth). The accepting section 201 may also accept, as the request, information which indicates the property of the subject of growth, such as the variety of the subject of growth. In a cases where the subject of growth is being grown, the accepting section 201 may accept, as the request, the growth state, the growth environment, the task history, etc. of the subject of growth.

The graph generating section 202 generates a to-be-grown graph in which the subject of growth is represented as a graph, in accordance with information regarding the subject of growth. For example, the graph generating section 202 may generate the to-be-grown graph by expressing the subject of growth as a node and linking, to the node, a node which indicates the property, growth state, growth environment, and task history of the subject of growth. It should be noted that the information regarding the property of the subject of growth may be contained in the request accepted by the accepting section 201, or may be retrieved from a database or the like in which the properties of various crops are accumulated. In addition, the growth environment may be identified by analyzing a database in which the climates and meteorological information of a cultivation area are accumulated.

On the basis of various kinds of information regarding a previously grown crop, the learning section 203 learns each relationship between nodes contained in a grown graph, which is, in other words, the relation between the method for growing the crop and the result of the growing, and generates the grown graph having been trained. The growth result contains the size, the taste, the harvest period, the harvest yield, etc. of a crop (more precisely, a harvested product). Unless otherwise specified, the grown graph refers to a trained graph generated through learning carried out by the learning section 203. Alternatively, a trained grown graph may be loaded into the crop growth assistance apparatus 2. In this case, the learning section 203 may be omitted.

The link prediction section 204 uses the above to-be-grown graph and grown graph, to predict a node to be linked to a node contained in the to-be-grown graph, from among the nodes regarding the tasks which are contained in the grown graph and which were performed during the growth of the previously grown crop, through a link prediction for predicting relationship between nodes which are not connected together via a link in the to-be-grown graph and the grown graph. A task indicated by the predicted node is a candidate for the growth method. For example, in a case of the example of FIG. 4, the link prediction section 204 predicts a task to be linked via the link “September” to the node “task history” in the to-be-grown graph. The predicted task becomes the candidate for the growth method.

The evaluating section 205 evaluates the recommendation level of the node predicted by the link prediction section 204, i.e., a candidate for the growth method, in accordance with another node contained in the grown graph which contains the node predicted by the link prediction section 204. Assume, for example, that it is predicted that the task to be linked via the link “September” to the node “task history” in the example of FIG. 4 is “a4”. In this case, the evaluating section 205 evaluates the recommendation level of the task “a4” in accordance with the other nodes (e.g., “high sugar content”, etc.) contained in the grown graph of the crop A. A method of the evaluation will be described later.

The generating section 206 generates response information which contains the method for growing the subject of growth, in accordance with a learned model having learned the relations between the methods for growing a plurality of crops and the results of the growing the plurality of crops and the request accepted by the accepting section 201. More specifically, the generating section 206 generates response information according to the node predicted by the link prediction section 204, i.e., the candidate for the growth method. This node indicates a task to be applied to the growth of the subject of growth. As described above, since the link prediction section 204 makes a link prediction with use of the grown graph, the generating section 206 generates response information in accordance with the learned model, by generating the response information in accordance with the result of the link prediction made by the link prediction section 204.

The basis generating section 207 generates basis information which indicates validity of the response information generated by the generating section 206. A method for generating the basis information will be described later.

The outputting section 208 outputs various kinds of information generated by the crop growth assistance apparatus 2. For example, the outputting section 208 outputs information such as the response information generated by the generating section 206 and the basis information generated by the basis generating section 207. The information is outputted to any destination. For example, in a case where the crop growth assistance apparatus 2 includes output equipment as described above, the information may be outputted to the output equipment. As another example, the information may be outputted to output equipment external to the crop growth assistance apparatus 2.

As described above, the learned model used by the crop growth assistance apparatus 2 may be a grown graph which contains a plurality of nodes regarding a previously grown crop and links each indicating relationship between the corresponding nodes of the plurality of nodes and which has learned the relationship between nodes of the plurality of nodes. With this configuration, it is possible to generate response information which indicates a proper method for growing the subject of growth, in consideration of the mutual relationship between, for example, the method for growing a previously grown crop and the result of the growing, and output the response information.

As above, the crop growth assistance apparatus 2 may include a link prediction section 204 which uses the above to-be-grown graph and grown graph, to predict a node to be linked to a node contained in the to-be-grown graph, from among the nodes regarding the tasks which are contained in the grown graph and which were performed during the growth of a previously grown crop, through a link prediction for predicting relationship between nodes which are not connected together via a link in the to-be-grown graph and the grown graph. Further, the generating section 206 may generate response information according to the node predicted by the link prediction section 204.

A node which is related to a task carried out during the growth of a previously grown crop and which is to be linked to a node contained in the to-be-grown graph can be related to a task carried out during the growth of the subject of growth. Assume, for example, that a node indicating that the frequency of watering task is reduced is contained in the grown graph of a crop which has previously been grown and the growth result of which was good, and it is predicted that this node is linked to a node contained in the to-be-grown graph. In this case, the crop which is the subject of growth is expected to provide a good growth result, by reducing the frequency of watering task. Thus, with the above configuration, it is possible to provide useful information regarding the task to be performed on the subject of growth.

### (Link Prediction)

The link prediction section 204 can predict a node which matches a designated condition. The designation of a condition may be provided in advance, or can be provided by a user. In the latter case, the accepting section 201 may accept the input of a condition as the request.

For example, in a case where the accepting section 201 accepts the input of a condition regarding the grown graph, the link prediction section 204 may predict a node to be linked to a node contained in the to-be-grown graph, from among the nodes regarding the tasks performed during the growth of a previously grown crop.

This configuration makes it possible to predict a node as intended by a user. For example, in a case where a user inputs a condition of “achievement of a predetermined growth result”, a node to be linked to a node contained in the to-be-grown graph is predicted from the grown graph that indicates achievement of such a growth result regarding the tasks performed during the growth. In this case, it is possible to provide useful information regarding a task which is likely to lead to the predetermined growth result.

Besides the above condition, a condition described below by way of example may be set. It should be noted that, for the purpose of judging whether a condition is met, a grown graph having learned information related to the meeting of the condition is used. For example, in a case where a condition of low task costs is applied from among the following conditions, the grown graph that contains a node and a link which indicate task costs is used.
A growth goal (which may be a final goal, or may be an interim goal) set by a user is achieved.
Preconditions such as a crop, a growth environment, and usable material and equipment are matched (perfect match or partial match).
An after-task growth environment indicated in the growth history agrees with a meteorological forecast (e.g., in a case where temperatures in September are forecasted to be high, tasks are extracted from the graph of a crop having the growth history in which temperatures in September were high).
Task costs (hours of task, labor strength, costs, etc.) are low.
Cultivation is carried out organically, or the amount of usage of pesticides is reduced.
A predetermined range of yield is expected in a predetermined time period.

### (Evaluation of Node)

As described above, the evaluating section 205 evaluates the recommendation level of the node predicted by the link prediction section 204, in accordance with another node contained in the grown graph which contains the node predicted by the link prediction section 204. The evaluation made by the evaluating section 205 will be described below.

A node linked to a node contained in the to-be-grown graph can provide a user with a useful suggestion regarding tasks suitable for the subject of growth. Further, another node which is contained in the grown graph containing such a node is likely to be related to the growth of the subject of growth. Assume, for example, that a grown graph contains a node and a link which indicate that the yield of a grown crop is high. In this case, a node which is contained in the grown graph and which is linked to a node contained in the to-be-grown graph is likely to indicate information which contributes to an improvement in the yield of the subject of growth. Therefore, it can be said that the recommendation level of such a node is high.

Thus, with the above configuration, the recommendation level of the node predicted by the link prediction section 204 is evaluated in accordance with another node contained in the grown graph which contains the node predicted by the link prediction section 204. A user may then determine a task to be performed on the subject of growth, with reference to the evaluation. This makes it possible to contribute to the determination on a task promising for more preferable growth result.

A method for the evaluation may be determined in advance in accordance with a node to be evaluated, etc., and various measures of the evaluation can be used. For example, the degree of suitability for a request may be a measure of the evaluation. Assume, for example, that the quality required of the harvested product of the subject of growth is contained in a request. In this case, the evaluating section 205 may make evaluation such that the evaluation of a node corresponding to a grown graph containing a node which indicates the quality is higher than a node corresponding to a grown graph not containing the node which indicates the quality.

The evaluating section 205 may express an evaluation result as a numerical value. According to the present example embodiment, an example in which the evaluating section 205 calculates the recommendation level of the node predicted by the link prediction section 204 will be described. In this case, by creating, in advance, a rule regarding a relation between a node contained in the grown graph and the recommendation level, it is possible for the evaluating section 205 to follow the rule to calculate the recommendation level of each node.

For example, the evaluating section 205 may calculate the recommendation level with use of at least one of the measures indicated below, with respect to the grown graph containing the node predicted by the link prediction section 204.
When a node and a link which indicate that the growth goal set by a user is achieved is contained, add a point, and when such a node and a link are not contained, deduct a point.
When more nodes and links which indicate that the degree of match with preconditions such as crop species, a variety, a growth environment, and usable material and equipment is high are contained, add more points, and when fewer nodes and links which indicate the same are contained, deduct more points.
When more nodes and links which indicate that the growth environment is similar are contained, add more points, and when fewer nodes and links which indicate the same are contained, deduct more points (in a case of a crop which is being grown, the similarity in growth environment may be judged with use of the result of meteorological forecast).
When a node and a link which indicate that the task costs (hours of task, labor strength, costs. etc.) are high are contained, deduct a point, and when fewer nodes and links which indicate the same are contained, add more points.
When a node and a link which indicate that the amount of usage of pesticides is great are contained, deduct a point, and when a node and a link which indicate the same are contained, add a point.
When a node and a link which indicate that there was a user-designated range of yield in a user-designated time period are contained, add a point, and when a node and a link which indicate that there is a deviation from the time period or yield are contained, deduct a point.

### (Method for Generating Basis Information)

As described above, the basis generating section 207 generates basis information which indicates the validity of the response information generated by the generating section 206. For example, the basis generating section 207 may generate basis information which contains a previous instance similar to the method for growing the subject of growth. This makes it possible for a user to refer to the response information in light of the basis information, to accurately judge the validity of the response information.

For example, the basis generating section 207 may generate basis information which is the entire grown graph which contains the node predicted by the link prediction section 204, or which is a part of the grown graph. Alternatively, for example, the basis generating section 207 may search for a grown graph which contains the node predicted by the link prediction section 204 and contains a predetermined number or more of common nodes shared with the method for growing the subject of growth, to generate basis information which is the entire grown graph detected by this search or a part of the grown graph.

### (Generation of Basis for Link Prediction Result)

The basis generating section 207 can generate basis information by analyzing a to-be-grown graph and a grown graph. A method for generating basis information by analyzing a to-be-grown graph and a grown graph will be described below.

For example, the basis generating section 207 may mine one or more rules from a to-be-grown graph and a grown graph with use of principal component analysis (PCA) reliability based on open-world assumption (OWA). The basis generating section 207 may generate basis information using one or more rules that have been mined. For example, a method described in the following literature can be applied to the mining of a rule.

Luis Galarraga et al, “Fast rule mining in ontological knowledge bases with AMIE+”, The VLDB Journal (2015) 24: 707-730

As an example, a rule to be processed by the basis generating section 207 is expressed with use of Head r(x, y) and Body {B1, . . . , Bn} as follows:

$${B}_{1} ∧ {B}_{2} ∧ … {B}_{n} ⇒ r ( x , y )$$

This rule may also be expressed in vector representation as follows:

$$\vec{B} ⇒ r ( x , y )$$

Head r(x, y) is also referred to as atom.

As a condition of the mining process, the basis generating section 207 imposes the following conditions to carry out the mining process:
Connected: all values (variables, entities) in a rule are shared between different atoms;
Closed: all variables in a rule appear two times or more; and
Not reflexive: a rule containing a reflective atom (such as r(x, x)) is not mined.

The basis generating section 207 may use a head coverage (hc) defined by

$$hc ( \vec{B} ⇒ r ( x , y ) ) := \frac{supp ( \vec{B} ⇒ r ( x , y ) )}{size ( \text{?} )}$$

$$\text{?} \text{indicates text missing or illegible when filed}$$

and PCA reliability defined by

$${conf}_{pca} ( \vec{B} ⇒ r ( x , y ) ) = \frac{supp ( \vec{B} ⇒ r ( x , y ) )}{\text{?} ( x , y ) : \text{?} … , \text{?} : \vec{B} ∧ r ( x , {y}^{′} )}$$

$$\text{?} \text{indicates text missing or illegible when filed}$$

to carry out the mining process. By using PCA reliability, it is possible to mine a highly accurate rule, as compared with a case of using standard reliability. Therefore, by using the above configuration, it is possible for the basis generating section 207 to generate highly reliable basis information.

Assume, for example, that the basis generating section 207 has mined the following rule: “in a case where the growth environment immediately before harvest is the same as in an average year, reducing the frequency of watering immediately before harvest” makes it “possible to obtain harvested products having a high sugar content”. In this case, when the link prediction section 204 predicts the task of reducing the frequency of watering, the basis generating section 207 may generate basis information indicating the above rule, which is the basis for this prediction.

### (Flow of Process)

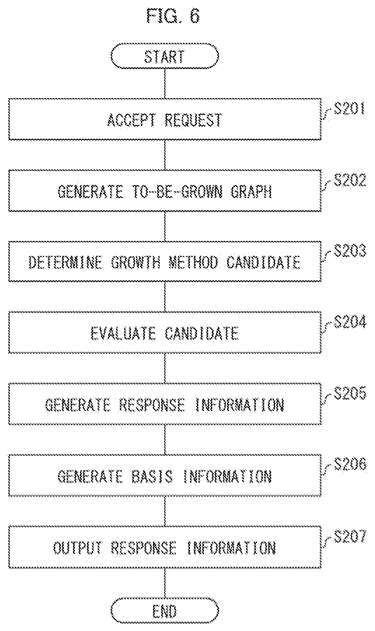

A flow of the process (crop growth assistance method) carried out by the crop growth assistance apparatus 2 will be described below on the basis of FIG. 6. FIG. 6 is a flowchart illustrating a flow of a process carried out by the crop growth assistance apparatus 2.

In S201, the accepting section 201 accepts a request regarding the subject of growth. In S201, for example, the accepting section 201 accepts a request containing any of the size, the taste, the harvest period, and the harvest yield of the subject of growth (more precisely, a harvested product obtained by growing the subject of growth). Subsequently, in S202, the graph generating section 202 generates a to-be-grown graph in accordance with the information inputted in S201.

In S203, the link prediction section 204 determines a candidate for the growth method. Specifically, the link prediction section 204 predicts a node to be linked to a node contained in the to-be-grown graph, from among the nodes regarding the tasks which are contained in a grown graph and which were performed during the growth of a previously grown crop, through a link prediction with use of the to-be-grown graph generated in S202 and the grown graph. The task indicated by this node is a candidate for the growth method. In connection with the process of S203, the basis generating section 207 may generate basis information indicating the basis for the prediction result provided by the link prediction section 204, by analyzing the to-be-grown graph and the grown graph.

In S204, the evaluating section 205 evaluates the candidate for the growth method determined in S203. Specifically, the evaluating section 205 evaluates the recommendation level of the candidate, in accordance with a node contained in the grown graph related to the candidate for the growth method. It should be noted that in a case where a plurality of candidates are determined in S203, the evaluating section 205 makes an evaluation for each of the candidates determined.

In S205, the generating section 206 generates response information in accordance with the candidate determined in S203 and the request accepted in S201. As described above, the grown graph is a learned model. A candidate for the growth method is determined through a link prediction made with use of the grown graph. Therefore, it can be said that the response information is generated in S205 in accordance with the learned model and the request accepted in S201.

As an example, the generating section 206 may generate the response information that indicates candidates which are included in the candidates determined in S203 and which are ranked in places from the top to a predetermined ranking for the evaluation result provided in S204. As another example, the generating section 206 may generate the response information that indicates candidates which are included in the candidates determined in S203 and which match the request accepted in S201. In addition, as still another example, the generating section 206 may generate the response information which indicates the candidates determined in S203 and the evaluation results provided in S204.

In S206, the basis generating section 207 generates basis information indicating the validity of the response information generated in S205. For example, the basis generating section 207 may detect, in the grown graph, a previous growth instance similar to the method for growing the subject of growth, to generate the basis information that contain the growth instance detected.

In S207, the outputting section 208 outputs the response information generated in S206. Further, in this outputting, the outputting section 208 may also output the basis information generated in S206. With this, the process of FIG. 6 ends.

### (Example of Response Information)

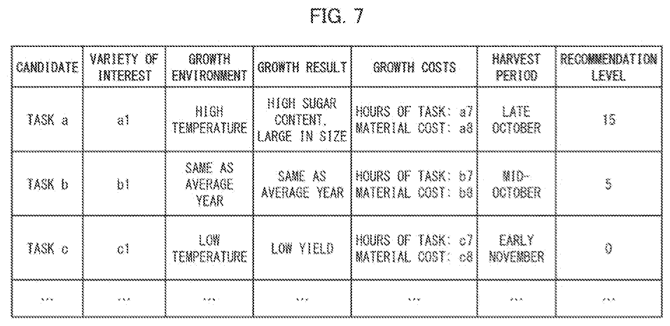

In S207, the response information as illustrated by way of example in FIG. 7 may be outputted. FIG. 7 is a diagram illustrating an example of the response information. The response information illustrated in FIG. 7 contains a total of seven items which are the “candidates” for a method for growing the subject of growth, the “variety of interest” to which the method is applied, the “growth environment”, “growth result”, and “growth costs” of the crop grown by the method, the “harvest period”, and the “recommendation level”.

The “candidates” are predicted by the link prediction section 204. In the example of FIG. 7, tasks a to c are included in the candidates. The tasks a to c each may indicate the type of a task, may indicate the details of a task, or may indicate the type and details of a task.

The “variety of interest” to “harvest period” are identified on the basis of the grown graphs of the candidates predicted by the link prediction section 204. In the example of FIG. 7, hours of task and material cost are indicated as the “growth costs”. Besides, the “growth costs” may also contain, for example, the labor strength of a task which is a “candidate”. The basis generating section 207 may generate the basis information which contains such kinds of information.

The “recommendation level” indicate an evaluation result provided by the evaluating section 205 with respect to a candidate. The evaluating section 205 may calculate the recommendation level in accordance with various kinds of information identified on the basis of the grown graph. In the example of FIG. 7, the recommendation levels of the tasks a, b, and c are, 15, 5, and 0, respectively. For example, a rule may be determined in advance as follow: the recommendation level is +5 when the “variety of interest” and the “growth environment” agree with those of the subject of growth, the recommendation level is +5 when one of the growth results requested is included, the recommendation level is +5 when the growth costs are not higher than the upper limit requested, and the recommendation level is +5 when the harvest period agrees with the time period requested. This makes it possible for the evaluating section 205 to calculate, according to the rule, the recommendation level of each of the candidates illustrated in FIG. 7.

### Third Example Embodiment

### (Outline)

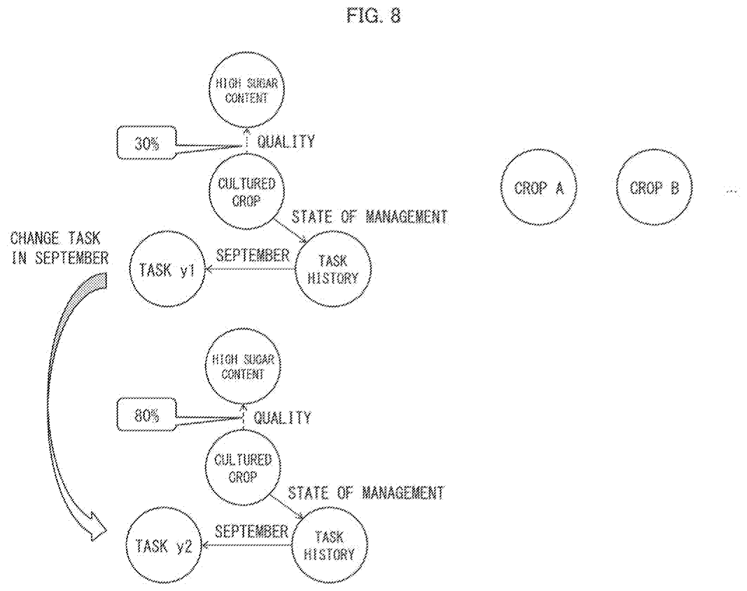

FIG. 8 is a diagram illustrating an outline of a crop growth assistance method in accordance with the present example embodiment. According to the present example embodiment, an example in which searching for a method for growing the subject of growth, the method matching a request, while a to-be-grown graph containing a plurality of nodes related to the subject of growth is updated will be described.

According to the present example embodiment, like the second example embodiment, a to-be-grown graph and a grown graph are used to make a link prediction. The to-be-grown graph illustrated in the upper left part of FIG. 8 contains a node and link which indicate that a “task y1” was performed in September, regarding the states of management of a cultured crop so far.

Although a grown graph containing a node “crop A” and a grown graph containing a node “crop B” are illustrated as the grown graphs in FIG. 8, the illustration of other nodes and links are omitted.

By learning various kinds of grown graphs as described above, it is possible to make a link prediction of a possible growth result and a growth method which provides such a growth result. That is, with the crop growth assistance method in accordance with the present example embodiment, a provisional to-be-grown graph is generated, and a link prediction of a probability that the subject of growth indicated in the to-be-grown graph will have the growth result requested is made.

For example, in the example of FIG. 8, a probability that the node “high sugar content” is connected via the link “quality” to the node “cultured crop” of the to-be-grown graph illustrated in the upper left part is predicted to be 30%. It cannot be said that this probability is sufficiently high.

To address this, as illustrated in the lower part of the same figure, a node connected via a link “September” to the node “task history” connected to the node “cultured crop” of the to-be-grown graph is changed from the “task y1” to a “task y2”, and a link prediction is made again. This changes the prediction result of the probability that the node “high sugar content” is connected via the link “quality” to the node “cultured crop” to 80%.

With the crop growth assistance method in accordance with the present example embodiment, it is possible to recommend, on the basis of the result of the above processes, the “task y2” as a task of September performed to impart the quality of “high sugar content” to a cultured crop which is the subject of growth.

### (Configuration of Apparatus)

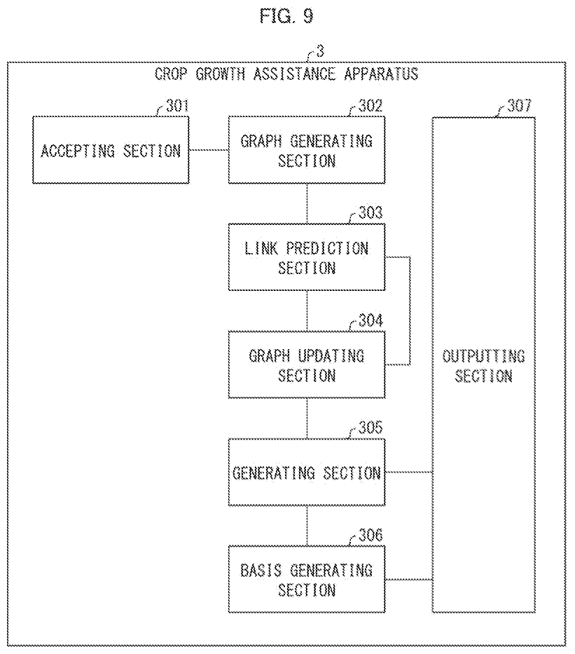

A configuration of a crop growth assistance apparatus 3 in accordance with the third example embodiment of the present invention will be described below on the basis of FIG. 9. FIG. 9 is a block diagram illustrating a configuration of the crop growth assistance apparatus 3 of the present example embodiment.

The crop growth assistance apparatus 3 includes an accepting section 301, a graph generating section 302, a link prediction section 303, a graph updating section 304, a generating section 305, a basis generating section 306, and an outputting section 307, as illustrated. In addition to these components, the crop growth assistance apparatus 3 may include, for example, a learning section, input equipment, output equipment, and communication equipment, like the crop growth assistance apparatus 2 of the second example embodiment.

The accepting section 301 accepts a request regarding the subject of growth. For example, the accepting section 301 accepts a request containing any of the size, the taste, the harvest period, and the harvest yield of the subject of growth (more precisely, a harvested product obtained by growing the subject of growth). The accepting section 301 may further accept the input of at least one selected from the group consisting of the details and a timing of a task to be performed on the subject of growth. The input may be accepted as a part of the request, or may be accepted as an input separate from the request. In addition, the details and the timing of a task performed on the subject of growth may contain the details and the timing of a task which was previously performed on the subject of growth, or may contain the details and the timing of a task to be performed on the subject of growth in the future.

The graph generating section 302 generates a to-be-grown graph in accordance with the request. The to-be-grown graph generated by the graph generating section 302 contains a node which indicates at least one selected from the group consisting of the details and the timing of a task and which indicate the details and the timing of a task to be performed on the subject of growth in the future. For example, the graph generating section 302 may generate the to-be-grown graph in which a node indicating “task history” is connected via a link indicating “state of management” to a node indicating “cultured crop”, and a “task y1” is connected via a link “September” to the node indicating “task history”, as illustrated in FIG. 8. The node “task y1” connected via the link “September” to the node indicating “task history” indicates the details of the task to be performed on the subject of growth in the future. In addition, the to-be-grown graph may contain a node and a link which indicate the size, the taste, the harvest period, the harvest yield, etc. of the subject of growth (more precisely, a harvested product obtained by growing the subject of growth).

The link prediction section 303 uses the to-be-grown graph generated by the graph generating section 302 and a trained grown graph, to calculate a probability that a node indicating a predetermined growth result is linked to the to-be-grown graph, through a link prediction for predicting relationship between nodes which are not connected together via a link in the to-be-grown graph and the grown graph. The predetermined growth result is identified in accordance with the request, as an example. For example, in a case where a quality of “high sugar content” is requested as the growth result required of the subject of growth, the link prediction section 303 calculates a probability that a node indicating the quality is linked to a node (e.g., the node “cultured crop” in the example of FIG. 8) contained in the to-be-grown graph.

The graph updating section 304 updates the to-be-grown graph. As an example, the graph updating section 304 carried out at least one selected from the group consisting of a process of replacing, with a node of the details of another task, the node which is contained in the to-be-grown graph and which indicates the details of a task to be performed on the subject of growth in the future and a process of adding a node of the details of a new task.

The update of the to-be-grown graph may be carried out according to the input of a user, or may be automatically carried out. In the former case, the graph updating section 304 may cause the outputting section 307 to output a task detail list extracted from the grown graph, so that the user can select the details of a new task from the list. In the latter case, the graph updating section 304 may select the details of a new task from among the details of tasks extracted from the grown graph.

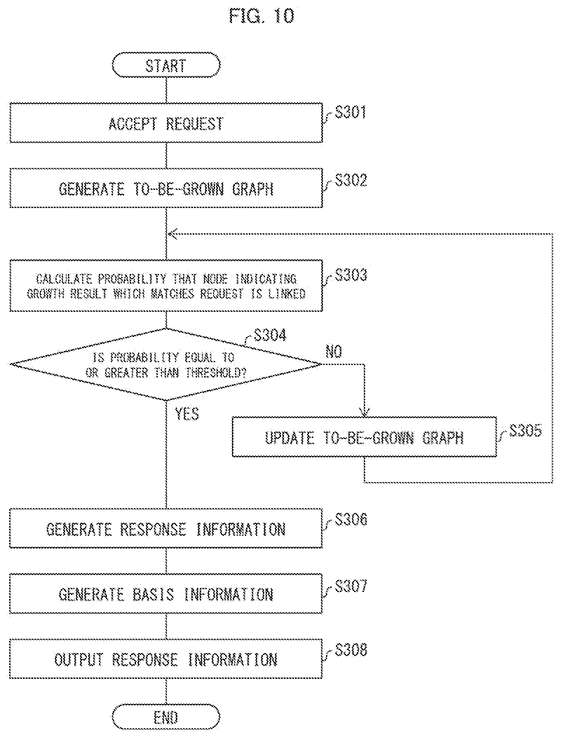

The generating section 305 generates response information containing a method for growing the crop which is the subject of growth, in accordance with the request and a learned model having learned relations between methods for growing a plurality of crops and growth results including any of the sizes, the tastes, the harvest periods, and the harvest yields of the plurality of crops. More specifically, the generating section 305 generates the response information in accordance with a probability calculated by the link prediction section 303. The specific example of generating the response information will be described later on the basis of FIG. 10.

As above, the link prediction section 303 uses a grown graph which is a learned model and a to-be-grown graph generated in accordance with a request, to make a link prediction. The generating section 305 therefore generates the response information based on the learned model and the request, by generating the response information in accordance with the result of the link prediction made by the link prediction section 303.

The basis generating section 306 generates basis information which indicates validity of the response information generated by the generating section 305. Specifically, the basis generating section 306 generates the basis information which contains a previous instance similar to the method for growing the crop which is the subject of growth. Further, the basis generating section 306 may generate the basis information regarding the result of the link prediction made by the link prediction section 303, by analyzing the to-be-grown graph and the grown graph.

The outputting section 307 outputs various kinds of information generated by the crop growth assistance apparatus 3. For example, the outputting section 307 outputs information such as the response information generated by the generating section 305 and the basis information generated by the basis generating section 306. Like the outputting section 208 of the second example embodiment, the destination to which the information is outputted is not particularly limited.

As above, in the crop growth assistance apparatus 3, the accepting section 301 accepts the input of at least one selected from the group consisting of the details and the timing of a task to be performed on the subject of growth, and the link prediction section 303 calculates a probability that a node indicating a predetermined growth result is linked to the to-be-grown graph, with use of a grown graph and a to-be-grown graph which contains a node indicating at least one selected from the group consisting the details and the timing of the task inputted, through a link prediction for predicting relationship between nodes which are not connected together via a link in the to-be-grown graph and the grown graph.

It can be said that the to-be-grown graph which contains a node indicating at least one selected from the group consisting of the details and the timing of a task to be performed on the subject of growth indicates the state of the subject of growth on which the task has been performed. It can therefore be said that the probability that a node indicating a predetermined growth result is linked to this to-be-grown graph indicates the possibility that the predetermined growth result is obtained through the task. That is, with the above configuration, it is possible to predict, before performing a task which will be performed by the grower, whether a predetermined growth result is likely to be obtained through the task.

### (Flow of Process)

A flow of the process (crop growth assistance method) carried out by the crop growth assistance apparatus 3 will be described below on the basis of FIG. 10. FIG. 10 is a flowchart illustrating a flow of a process carried out by the crop growth assistance apparatus 3.

In S301, the accepting section 301 accepts a request regarding the subject of growth. For example, the accepting section 301 accepts a request containing any of the size, the taste, the harvest period, and the harvest yield of the subject of growth (more precisely, a harvested product obtained by growing the subject of growth). The accepting section further accepts the input of at least one selected from the group consisting of the details and the timing of a task to be performed on the subject of growth.

In S302, the graph generating section 302 generates a to-be-grown graph in accordance with the information inputted in S301. For example, in S301, in a case where the input of at least one selected from the group consisting of the details and the timing of a task to be performed on the subject of growth is accepted, the graph generating section 302 may generate a to-be-grown graph which contains a node of at least one selected from the group consisting of the details and the timing of the task to be performed on the subject of growth.

In S303, the link prediction section 303 calculates a probability that a node indicating a predetermined growth result which matches the request accepted in S301 is linked to a node contained in the to-be-grown graph generated in S302. As described above, the calculation of this probability is performed through a link prediction made with use of a trained grown graph and the to-be-grown graph. In connection with the process of S303, the basis generating section 306 may generate basis information indicating the basis for calculation result provided by the link prediction section 303, by analyzing the to-be-grown graph and the grown graph.

In S304, the graph updating section 304 judges whether the probability calculated in S303 is equal to or greater than a threshold. In a case where the probability is judged to be equal to or greater than a threshold (“YES” in S304), the process proceeds to S306, and in a case where the probability is judged to be smaller than the threshold (“NO” in S304), the process proceeds to S305.

It should be noted that in a case where a plurality of growth results are indicated in the request accepted in S301, the prediction is made for each of the growth results in S303, and the judgment in S304 may be “YES” in a case where the probabilities for all the growth results are equal to or greater than a threshold, and may be “NO” in a case where any of the growth results is smaller than the threshold. This makes it possible to presume a growth method which can satisfy all the growth results required.

In S305, the graph updating section 304 updates the to-be-grown graph. As an example, the graph updating section 304 replaces, with a node which indicates the details of another task, the node which is contained the current to-be-grown graph and which indicates the details of a task to be performed on the subject of growth in the future. As described above, the details of update may be determined according to the input from a user, or may be determined by the graph updating section 304.

When the to-be-grown graph is updated, the process is returned to S303, and the probability is calculated again. That is, in the process of FIG. 10, the calculation of a probability in S303 and the update of the to-be-grown graph in S305 are repeated until the judgment in S304 becomes “YES”.

In S306, the generating section 305 presumes a growth method for obtaining a predetermined growth result which matches the request accepted in S301, and generates response information containing the growth method presumed. Specifically, the generating section 305 presumes that a growth method indicated in the to-be-grown graph when the judgment in S304 is “YES” is a growth result which matches the request, and generates response information indicating the growth method.

In S307, the basis generating section 306 generates basis information indicating the validity of the response information generated in S306. Specifically, the basis generating section 306 generates the basis information which contains a previous instance similar to the method for growing the crop which is the subject of growth.

In S308, the outputting section 307 outputs the response information generated in S306. In addition, in this outputting, the outputting section 307 may also output the basis information generated in S307. With this, the process of FIG. 10 ends.

### Supplementary Matters Regarding Third Example Embodiment

The manner of generating the to-be-grown graph in accordance with the present example embodiment is not limited to the above example. For example, the crop growth assistance apparatus 3 in accordance with the present example embodiment may include a component the same as the link prediction section 204 in accordance with the second example embodiment. In this case, the graph generating section 302 in accordance with the present example embodiment may generate a to-be-grown graph that contains nodes which form at least a part of the growth method predicted by the link prediction section 204 and which indicate the details and the timing of a task to be performed on the subject of growth in the future.

In addition, in a case of the above configuration, the graph updating section 304 in accordance with the present example embodiment may replace, with a node which indicates the details of another task predicted by the link prediction section 204, the node which is contained in the current to-be-grown graph and which indicates the details of a task to be performed on the subject of growth in the future. According to the flow of FIG. 10, the details or the timing of the task to be performed on the subject of growth is predicted through a link prediction before the process of S305, and the update in S305 is carried out according to a result of the prediction.

### Fourth Example Embodiment

### (Outline)

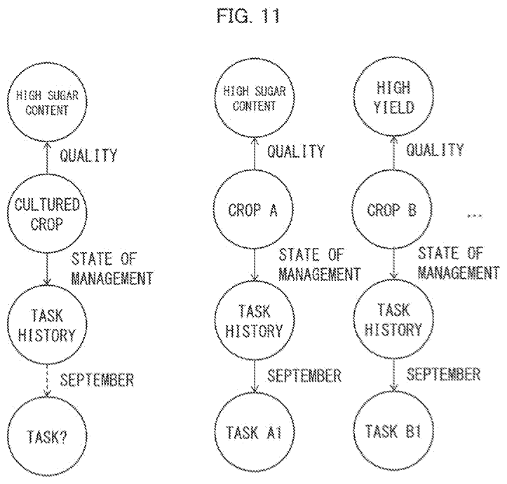

FIG. 11 is a diagram illustrating an outline of a crop growth assistance method in accordance with the present example embodiment. According to the present example embodiment, an example in which a to-be-grown graph containing a node that indicates a desired growth result is used to predict a growth method for obtaining the desired growth result will be described.

According to the present example embodiment, like the second and third example embodiments, a to-be-grown graph and a grown graph are used to make a link prediction. The to-be-grown graph illustrated in the upper left part of FIG. 11 contains a node and a link that indicate “high sugar content” as a quality which is an example of a desired growth result in relation to a cultured crop.

In FIG. 8, indicated as a grown graph of a crop A is a grown graph which contains: a node “crop A”; a node indicating “high sugar content” connected via a link “quality” to the node “crop A”; and a node “task A1” connected via a node “task history” and a link “September” to the node “crop A”. Further, indicated as a grown graph of a crop B is a grown graph which contains: a node “crop B”; a node indicating “high yield” connected via a link “quality” to the node “crop B”; and a node “task B1” connected via a node “task history” and a link “September” to the node “crop B”.

By learning various kinds of grown graphs as described above, it is possible to make a link prediction of a possible growth result and a growth method which provides such a growth result. As an example, in the crop growth assistance method in accordance with the present example embodiment, a to-be-grown graph containing the node indicating “high sugar content” as a quality desired by a user is generated, as illustrated in FIG. 11, and the details of a task (the “task” connected via the link “September” to the node of a task history in FIG. 11) for imparting the desired quality to the subject of growth indicated in the to-be-grown graph is predicted through a link prediction.

As above, in the crop growth assistance method in accordance with the present example embodiment, a to-be-grown graph containing a node indicating the growth result desired by a user is generated, and a growth method for the subject of growth indicated in the to-be-grown graph to obtain a desired growth result is predicted through a link prediction. This makes it possible to provide a user with material for determining a task necessary to obtain a desired growth result.

### (Configuration of Apparatus)

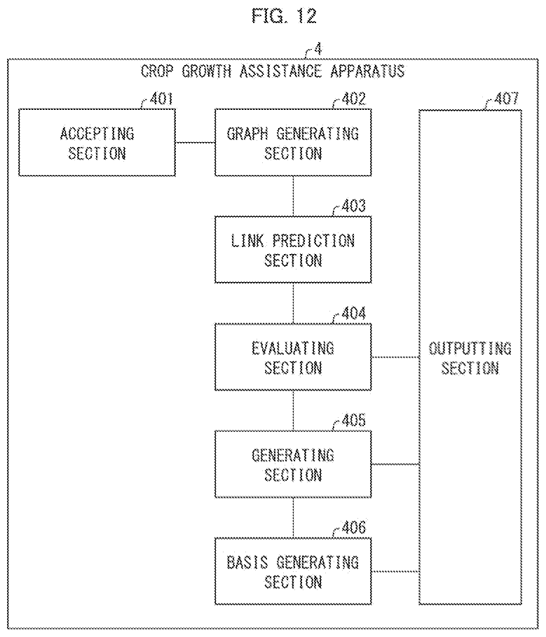

A configuration of a crop growth assistance apparatus 4 in accordance with the fourth example embodiment of the present invention will be described below on the basis of FIG. 12. FIG. 12 is a block diagram illustrating a configuration of the crop growth assistance apparatus 4 of the present example embodiment.

The crop growth assistance apparatus 4 includes an accepting section 401, a graph generating section 402, a link prediction section 403, an evaluating section 404, a generating section 405, a basis generating section 406, and an outputting section 407, as illustrated. In addition to these components, the crop growth assistance apparatus 4 may include, for example, a learning section, input equipment, output equipment, and communication equipment, like the crop growth assistance apparatus 2 or the crop growth assistance apparatus 3 of the above example embodiments.

The accepting section 401 accepts a request regarding the subject of growth. For example, the accepting section 401 accepts a request containing any of the size, the taste, the harvest period, and the harvest yield of the subject of growth (more precisely, a harvested product obtained by growing the subject of growth). In addition, the accepting section 401 accepts the input of a desired growth result in relation to the subject of growth. The desired growth result may form a part of the request, or may be accepted as an input separate from the request. The accepting section 401 may further accept a task history regarding the subject of growth.

The graph generating section 402 generates a to-be-grown graph in accordance with the request. The to-be-grown graph generated by the graph generating section 402 contains a node indicating a desired growth result in relation to the subject of growth. For example, the graph generating section 302 may generate a to-be-grown graph in which a node indicating “quality” is connected via a link indicating “high sugar content” to a node indicating “cultured crop”, as illustrated in FIG. 11. Further, the to-be-grown graph may further contain a node indicating “task history”.

The link prediction section 403 uses the above to-be-grown graph and a grown graph, to predict a node to be linked to a node contained in the to-be-grown graph, from among the nodes regarding the tasks which are contained in the grown graph and which were performed during the growth of a previously grown crop, through a link prediction for predicting relationship between nodes which are not connected together via a link in the to-be-grown graph and the grown graph. For example, in a case of the example of FIG. 11, the link prediction section 403 predicts a task to be linked via a link “September” to the node “task history” in the to-be-grown graph. The predicted task becomes a candidate for the growth method.

The evaluating section 404 evaluates the recommendation level of the node predicted by the link prediction section 403, i.e., the candidate for the growth method, in accordance with another node contained in the grown graph which contains the node predicted by the link prediction section 403. Assume, for example, that it is predicted that the task to be linked via the link “September” to the node “task history” in the example of FIG. 11 is “A1”. “A1” is a node contained in the grown graph of the crop A. Thus, in this case, the evaluating section 404 evaluates the recommendation level of the task “A1” in accordance with another node (e.g., “high sugar content”) contained in the grown graph of the crop A.

The generating section 405 generates response information which contains the method for growing the subject of growth, in accordance with a learned model having learned the relations between the methods for growing a plurality of crops and the results of the growing and the request accepted by the accepting section 401. More specifically, the generating section 405 generates the response information according to the node predicted by the link prediction section 403, i.e., the candidate for the growth method. This node indicates a task to be applied to the growth of the subject of growth. As described above, since the link prediction section 403 makes a link prediction with use of the grown graph, the generating section 405 generates response information in accordance with the learned model, by generating the response information in accordance with the result of the link prediction made by the link prediction section 403. Note that the generating section 405 may generate the response information which contains a growth method which is included in growth method candidates predicted by the link prediction section 403 and the recommendation level of which is equal to or greater than a predetermined threshold, the recommendation level being evaluated by the evaluating section 404.

The basis generating section 406 generates basis information which indicates validity of the response information generated by the generating section 405. Specifically, the basis generating section 406 generates the basis information which contains a previous instance similar to the method for growing the crop which is the subject of growth. Further, the basis generating section 406 may generate the basis information regarding the result of the link prediction made by the link prediction section 403, by analyzing the to-be-grown graph and the grown graph.

The outputting section 407 outputs various kinds of information generated by the crop growth assistance apparatus 4. For example, the outputting section 407 outputs information such as the response information generated by the generating section 405 and the basis information generated by the basis generating section 406. Further, the outputting section 407 may further output the recommendation level evaluated by the evaluating section 404. Like the outputting section 208 or the outputting section 308 of the above example embodiments, the destination to which the information is outputted is not particularly limited.

As above, in the crop growth assistance apparatus 4, the accepting section 401 accepts the input of a desired growth result in relation to the subject of growth, and the link prediction section 403 uses a grown graph and a to-be-grown graph which contains a node indicating the growth result inputted, to predict a node to be linked to a node contained in the to-be-grown graph, from among the nodes regarding the tasks which are contained in the grown graph and which were performed during the growth of a previously grown crop, through a link prediction for predicting relationship between nodes which are not connected together via a link in the to-be-grown graph and the grown graph.

It can be said that the to-be-grown graph which contains a node indicating a desired growth result indicates the state of the subject of growth on which the various tasks for growth have been performed. Thus, a node to be linked to a node contained in this to-be-grown graph and which is related to a task having been performed during the growth of a previously grown crop is likely to indicate a factor in obtaining the desired growth result. Thus, with the above configuration, it is possible to provide material for determining a task necessary to obtain a desired growth result.

### (Flow of Process)

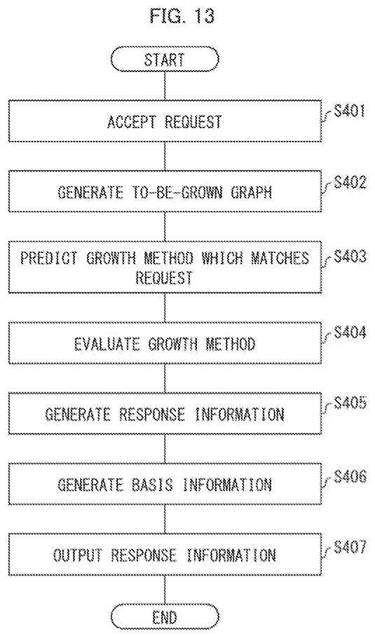

A flow of the process (crop growth assistance method) carried out by the crop growth assistance apparatus 4 will be described below on the basis of FIG. 13. FIG. 13 is a flowchart illustrating a flow of a process carried out by the crop growth assistance apparatus 4.

In S401, the accepting section 401 accepts a request regarding the subject of growth. For example, the accepting section 401 accepts a request containing any of the size, the taste, the harvest period, and the harvest yield of the subject of growth (more precisely, a harvested product obtained by growing the subject of growth). In addition, the accepting section 401 accepts the input of a desired growth result in relation to the subject of growth. The desired growth result may form a part of the request, or may be accepted as an input separate from the request. The accepting section 401 may further accept a task history regarding the subject of growth.

In S402, the graph generating section 402 generates a to-be-grown graph in accordance with the information inputted in S401. The to-be-grown graph generated by the graph generating section 402 contains a node indicating a desired growth result in relation to the subject of growth.

In S403, the link prediction section 403 predicts a node to be linked to a node contained in the to-be-grown graph generated in S402, from among the nodes regarding the tasks which are contained in a grown graph and which were performed during the growth of a previously grown crop. As described above, this node prediction is made through a link prediction made with use of a trained grown graph and the to-be-grown graph. In connection with the process of S403, the basis generating section 406 may generate basis information indicating the basis for the calculation result provided by the link prediction section 403, by analyzing the to-be-grown graph and the grown graph.

In S404, the evaluating section 404 evaluates the recommendation level of the node predicted by the link prediction section 403 in S403, i.e., a candidate for the growth method, in accordance with another node contained in the grown graph which contains the node predicted by the link prediction section 403 in S403.

In S405, the generating section 405 presumes a growth method for obtaining a desired growth result which matches the request accepted in S401, and generates response information containing the growth method presumed. As an example, the generating section 405 may generate the response information which contains a growth method which is included in growth method candidates predicted by the link prediction section 403 in S403 and the recommendation level of which is equal to or greater than a predetermined threshold, the recommendation level being evaluated by the evaluating section 404 in S404.

In S406, the basis generating section 405 generates basis information indicating the validity of the response information generated in S404. Specifically, the basis generating section 405 generates the basis information which contains a previous instance similar to the method for growing the crop which is the subject of growth.

In S407, the outputting section 407 outputs the response information generated in S406. In addition, in this outputting, the outputting section 407 may also output the basis information generated in S407 and the recommendation level evaluated in S404. With this, the process of FIG. 13 ends.

### Fifth Example Embodiment

### (Outline)

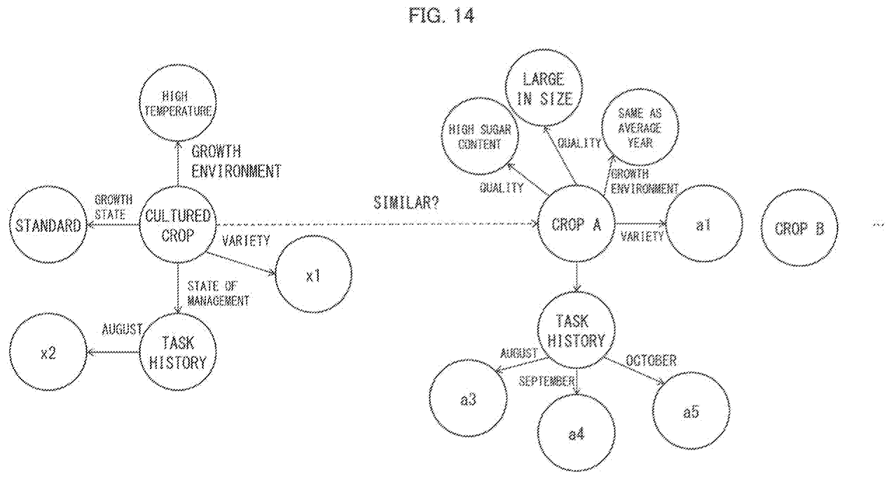

FIG. 14 is a diagram illustrating an outline of a crop growth assistance method in accordance with the present example embodiment. According to the present example embodiment, an example of assisting the growth of the subject of growth with use of a to-be-grown graph containing a plurality of nodes regarding the subject of growth and a plurality of grown graphs generated individually for the plurality of previously grown crops will be described.

In the crop growth assistance method in accordance with the present example embodiment, a request is accepted, the request containing at least one selected from the group consisting of the size, the taste, the harvest period, and the harvest yield of a crop which is the subject of growth.

Next, in the crop growth assistance method in accordance with the present example embodiment, a to-be-grown graph is generated in accordance with the request. In the example of FIG. 14, a graph containing a node “cultured crop” is the to-be-grown graph. This to-be-grown graph contains the nodes and links which indicate that the growth state, growth environment, and variety of the cultured crop so far are “standard”, “high temperature”, and “x1”, respectively, and the node and link which indicate that the task history of the cultured crop in August is “x2”.

In the crop growth assistance method in accordance with the present example embodiment, among the plurality of previously grown crops, a crop which has predetermined relationship with the subject of growth is identified, through a link prediction made with use of the to-be-grown graph generated as described above and a plurality of grown graphs generated individually for the plurality of previously grown crops. The subjects of the generation of grown graphs to be used are a plurality of crops, and the grown graphs to be used have learned the predetermined relationship among the plurality of crops.

In the example of FIG. 14, a previously grown crop similar to the subject of growth (hereinafter, also referred to as a similar crop) is predicted, through a link prediction made with use of the grown graphs of previously grown crop A, crop B, . . . , the grown graphs having learned similarity or dissimilarity therebetween. The expression of being “similar” means the similarity in graph. In this example, the training is conducted such that a dissimilar crop is not connected via a link “similar” (not being similar is a negative sample). However, the training may be conducted such that a link “dissimilar” is learned. Further, although the nodes and the links that indicate a task history, a growth environment, etc., are contained also in the crop B, the illustration thereof is omitted in FIG. 14.

Information on a crop similar to the subject of growth is useful for the growth of the subject of growth. Therefore, generating and outputting response information regarding a similar crop identified as described above makes it possible to provide information useful for the growth of a crop, and thus makes it possible to suitably assist the growth of the subject of growth.

In addition, it is possible to evaluate the similar crop identified as described above and determine, in accordance with a result of the evaluation, a similar crop to be contained in the response information. Assume, for example, that a request is accepted, the request indicating that a desired quality in relation to the subject of growth is “high sugar content”. In this case, if a similar crop identified has the quality of “high sugar content”, then the response information containing information on the similar crop may be generated. Conversely, if a similar crop identified does not have the quality of “high sugar content”, then the response information may be such that information on the similar crop is not contained.

### (Configuration of Apparatus)

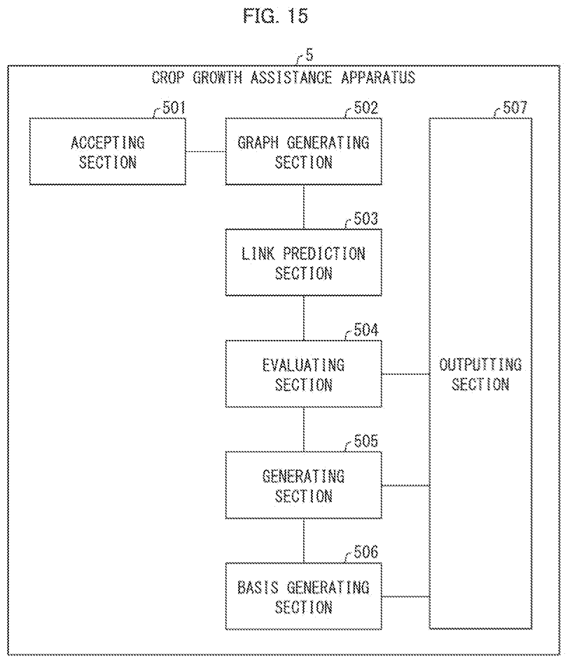

A configuration of a crop growth assistance apparatus 5 in accordance with the fifth example embodiment of the present invention will be described below on the basis of FIG. 15. FIG. 15 is a block diagram illustrating a configuration of the crop growth assistance apparatus 5 of the present example embodiment.

The crop growth assistance apparatus 5 includes an accepting section 501, a graph generating section 502, a link prediction section 503, an evaluating section 504, a generating section 505, a basis generating section 506, and an outputting section 507, as illustrated. In addition to these components, the crop growth assistance apparatus 5 may include, for example, a learning section, input equipment, output equipment, and communication equipment, like the crop growth assistance apparatuses 2 to 4 of the above example embodiments.

The accepting section 501 accepts a request regarding the subject of growth. For example, the accepting section 501 accepts a request containing any of the size, the taste, the harvest period, and the harvest yield of the subject of growth (more precisely, a harvested product obtained by growing the subject of growth). In addition, the accepting section 501 may accept the input of a desired growth result in relation to the subject of growth. The accepting section 501 may further accept a task history regarding the subject of growth.

The graph generating section 502 generates a to-be-grown graph in accordance with the request. The to-be-grown graph generated by the graph generating section 502 contains a plurality of nodes regarding the subject of growth, as illustrated in FIG. 14.

The link prediction section 503 identifies a crop which has predetermined relationship with the subject of growth and which is included in a plurality of previously grown crops, with use of the above to-be-grown graph and a plurality of grown graphs generated individually for the plurality of previously grown crops, through a link prediction for predicting relationship between nodes which are not connected together via a link in the to-be-grown graph and the grown graphs. The predetermined relationship may be relationship of similarity as in the example of FIG. 14, or may be another relationship. For example, the link prediction section 503 may identify a previously grown crop which is dissimilar to the subject of growth, or may identify, for example, a previously grown crop which belongs to the same classification as the subject of growth, or a previously grown crop having commonality in quality shared with the subject of growth.

The link prediction section 503 may make a link prediction without consideration of the task history in a time period which is later, in the course of growth, than the time period in which a request is accepted. For example, in a case where the details of a task to be performed in September is predicted in accordance with a request accepted in August, the link prediction may be made without consideration of a node regarding a task performed in and after September in a grown graph.

The evaluating section 504 evaluates the crop predicted by the link prediction section 503. As an example, the evaluating section 504 may evaluate the crop according to whether the crop predicted by the link prediction section 503 matches the request. Assume, for example, that a request is accepted, the request indicating that a desired quality in relation to the subject of growth is “high sugar content”. In this case, the recommendation level of a similar crop having a quality of “high sugar content” may be set to be higher than the recommendation level of a similar crop not having a quality of “high sugar content”.

Like the evaluating section 205 in accordance with the second example embodiment, the evaluating section 504 may represent the evaluation result as a numerical value. In this case, by creating, in advance, a rule regarding a relation between a node contained in the grown graph and the recommendation level, it is possible for the evaluating section 504 to follow the relation to calculate the recommendation level of the crop predicted by the link prediction section 503.

For example, the evaluating section 504 may calculate the recommendation level with use of at least one of the measures indicated below, with respect to the grown graph of the crop predicted by the link prediction section 503.
When a node and a link which indicate that the growth goal set by a user is achieved is contained, add a point, and when such a node and a link are not contained, deduct a point.
When more nodes and links which indicate that the degree of match with preconditions such as crop species, a variety, a growth environment, and usable material and equipment is high are contained, add more points, and when fewer nodes and links which indicate the same are contained, deduct more points.
When a node and a link which indicate that the task costs (hours of task, labor strength, costs. etc.) are high are contained, deduct a point, and when fewer nodes and links which indicate the same are contained, add more points.
When a node and a link which indicate that the amount of usage of pesticides is great are contained, deduct a point, and when a node and a link which indicate the same are contained, add a point.
When a node and a link which indicate that there was a user-designated range of yield in a user-designated time period are contained, add a point, and when a node and a link which indicate that there is a deviation from the time period or yield are contained, deduct a point.

The generating section 505 generates response information which contains the method for growing the subject of growth, in accordance with a learned model having learned the relations between the methods for growing a plurality of crops and the results of the growing and the request accepted by the accepting section 501. As an example, the generating section 505 generates response information according to the crop predicted by the link prediction section 503, the response information containing a method for growing the subject of growth. More specifically, the generating section 505 may generate the response information which contains the details and timing of a task which is capable of being performed on the subject of growth in the future, the details and the timing forming at least a part of a method contained in the grown graph of the similar crop predicted by the link prediction section 503.

As described above, since the link prediction section 503 makes a link prediction with use of the grown graph, the generating section 505 generates response information in accordance with the learned model, by generating the response information in accordance with the result of the link prediction made by the link prediction section 503. Note that the generating section 505 may generate the response information which contains a similar crop which is included in the similar crops predicted by the link prediction section 503 and the recommendation level of which is equal to or greater than a predetermined threshold, the recommendation level being evaluated by the evaluating section 504.

The basis generating section 506 generates basis information which indicates validity of the response information generated by the generating section 505. Specifically, the basis generating section 506 generates the basis information which contains a previous instance similar to the method for growing the crop which is the subject of growth. Further, the basis generating section 506 may generate the basis information regarding the result of the link prediction made by the link prediction section 503, by analyzing the to-be-grown graph and the grown graph.

The outputting section 507 outputs various kinds of information generated by the crop growth assistance apparatus 5. For example, the outputting section 507 outputs information such as the response information generated by the generating section 505 and the basis information generated by the basis generating section 506. Further, the outputting section 507 may further output the recommendation level evaluated by the evaluating section 504. Like the outputting sections 208, 308, and 408 of the above example embodiments, the destination to which the information is outputted is not particularly limited.

As above, the crop growth assistance apparatus 5 identifies a crop which has predetermined relationship with the subject of growth and which is included in a plurality of previously grown crops, with use of a to-be-grown graph containing a plurality of nodes regarding the subject of growth and a plurality of grown graphs generated individually for the plurality of previously grown crops, through a link prediction for predicting relationship between nodes which are not connected together via a link in the to-be-grown graph and the grown graphs.

Information on a crop having predetermined relationship with the subject of growth is useful for the growth of the subject of growth. Therefore, with the above configuration, it is possible to provide information useful for growth of a crop.

### (Flow of Process)

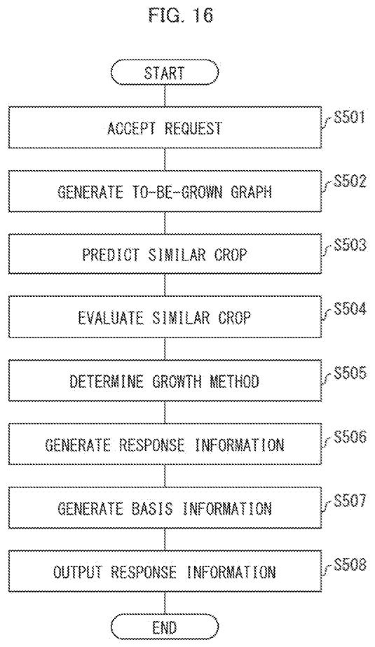

A flow of the process (crop growth assistance method) carried out by the crop growth assistance apparatus 5 will be described below on the basis of FIG. 16. FIG. 16 is a flowchart illustrating a flow of a process carried out by the crop growth assistance apparatus 4.

In S501, the accepting section 501 accepts a request regarding the subject of growth. For example, the accepting section 501 accepts a request containing any of the size, the taste, the harvest period, and the harvest yield of the subject of growth (more precisely, a harvested product obtained by growing the subject of growth). In addition, the accepting section may accept the input of a desired growth result in relation to the subject of growth. The accepting section 501 may further accept a task history regarding the subject of growth.

In S502, the graph generating section 502 generates a to-be-grown graph in accordance with the request. The to-be-grown graph generated by the graph generating section 502 contains a plurality of nodes regarding the subject of growth.

In S503, the link prediction section 503 identifies a crop (similar crop) which is similar to the subject of growth and which is included in a plurality of previously grown crops, with use of the above to-be-grown graph and a plurality of grown graphs generated individually for the plurality of previously grown crops, through a link prediction for predicting relationship between nodes which are not connected together via a link in the to-be-grown graph and the grown graphs.

In S504, the evaluating section 504 evaluates the crop predicted by the link prediction section 503 in S503. As an example, the evaluating section 504 may evaluate the crop according to whether the crop predicted by the link prediction section 503 in S503 matches the request.

In S505, the generating section 505 determines a method for growing the subject of growth, in accordance with a learned model having learned the relations between the methods for growing a plurality of crops and the results of the growing and the request accepted by the accepting section 501 in S501. More specifically, the generating section 505 determines that a method for growing the subject of growth is the growth method linked to a node of the crop predicted by the link prediction section 503 in S503. In this respect, the generating section 505 may determines that a method for growing the subject of growth is the growth method linked to a node of the crop which is predicted by the link prediction section 503 in S503 and the recommendation level of which is equal to or greater than a predetermined threshold, the recommendation level being evaluated by the evaluating section 504 in S504.

In S506, the generating section 505 generates response information containing the growth method determined in S505.

In S507, the basis generating section 505 generates basis information indicating the validity of the response information generated in S506. Specifically, the basis generating section 505 generates the basis information which contains a previous instance similar to the method for growing the crop which is the subject of growth.

In S508, the outputting section 507 outputs the response information generated in S506. In addition, in this outputting, the outputting section 507 may also output the basis information generated in S507 and the recommendation level evaluated in S504. With this, the process of FIG. 16 ends.

### Supplementary Matters Regarding Fifth Example Embodiment

The process carried out by the crop growth assistance apparatus 5 is not limited to the above example. For example, the crop growth assistance apparatus 5 may include components the same as the graph generating section 302, the link prediction section 303, and the graph updating section 304 in accordance with the third example embodiment. In a case of this configuration, for example, in S508, after outputting response information, the outputting section 507 may accept, from a user who refers to the response information, the details of growth to be performed on the subject of growth in the future. Subsequently, the graph generating section 302 may generate a to-be-grown graph in accordance with the details of growth accepted, the link prediction section 303 may use the generated to-be-grown graph to make a link prediction, and the graph updating section 304 may update the to-be-grown graph. As a result of these processes, the response information as described in the third example embodiment may be generated.

### [Variation]

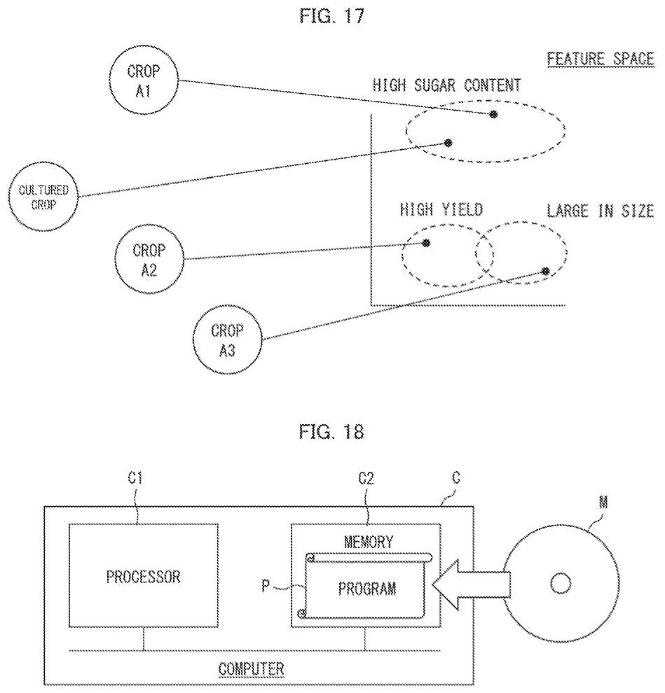

As described in the fourth example embodiment, by using a to-be-grown graph and a grown graph, it is possible to predict a result of growing the subject of growth (more precisely, a harvested product obtained by growing the subject of growth) through a link prediction. In addition, the prediction of a result of growing the subject of growth can be made by a method other than a link prediction. This will be described with reference to FIG. 17. FIG. 17 is an explanatory diagram of an example in which the result of growing the subject of growth is predicted in accordance with feature quantities calculated from a to-be-grown graph and a grown graph. FIG. 17 illustrates grown graphs of previously grown crops A1 to A3, and a to-be-grown graph of a cultured crop. The illustration of nodes and links contained in these graphs are omitted.

It is possible to calculate the feature quantity of each of the previously grown crops, by adding together the feature quantities of the respective nodes contained in a grown graph after multiplying each of the feature quantities by a weight according to a link connected to the corresponding node. Therefore, by conducting learning which is to update the weight such that a calculated feature quantity becomes in accordance with a result of growing the crop, it is possible to predict a result of growing the subject of growth, on the basis of the feature quantity of a graph of the type of the subject of growth, the feature quantity being calculated with the weights being applied.

For example, in the example of FIG. 17, learning is conducted such that a feature quantity calculated from the grown graph of the crop A1 which has been found to have a high sugar content falls within a range corresponding to the growth result of “high sugar content” in a feature space. In addition, learning is conducted such that a feature quantity calculated from the grown graph of the crop A2 which has been found to have a high yield falls within a range corresponding to the growth result of “high yield” in the feature space. Similarly, learning is conducted such that a feature quantity calculated from the grown graph of the crop A3 which has been found large in size falls within a range corresponding to the growth result of “large size” in the feature space.

In this case, if a feature quantity calculated from the to-be-grown graph falls within the range correspond to the growth result of “high sugar content”, then it is possible to predict that the subject of growth will provide the growth result of “high sugar content”. Such a method for predicting a growth result can be applied as a technique alternative to the growth result prediction methods in accordance with the above example embodiments.

### Software Implementation Example

Some or all of the functions of the crop growth assistance apparatuses 1 to 5 (hereinafter, the apparatuses) may be implemented by hardware such as an integrated circuit (IC chip), or may be implemented by software.

In the latter case, the apparatuses are provided by, for example, a computer that executes instructions of a program that is software implementing the foregoing functions. An example (hereinafter, computer C) of such a computer is illustrated in FIG. 18. The computer C includes at least one processor C1 and at least one memory C2. The memory C2 has recorded thereon a program (crop growth assistance program) P for causing the computer C to operate as the apparatuses. The at least one processor C1 of the computer C retrieves the program P from the memory C2 and executes the program P, so that the functions of the apparatuses are implemented.

Examples of the at least one processor C1 can include a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the memory C2 can include a flash memory, a hard disk drive (HDD), a solid state drive (SSD), and a combination thereof.

The computer C may further include a random access memory (RAM) into which the program P is loaded at the time of execution and in which various kinds of data are temporarily stored. The computer C may further include a communication interface via which data is transmitted to and received from another apparatus. The computer C may further include an input-output interface via which input-output equipment such as a keyboard, a mouse, a display or a printer is connected.

The program P can be recorded on a non-transitory, tangible recording medium M capable of being read by the computer C. Examples of such a recording medium M can include a tape, a disk, a card, a semiconductor memory, and a programmable logic circuit. The computer C can obtain the program P via such a recording medium M. Alternatively, the program P can be transmitted through a transmission medium. Examples of such a transmission medium can include a communication network and a broadcast wave. The computer C can obtain the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the above example embodiments.

### [Additional Remark 2]

The whole or part of the example embodiments disclosed above can be described as, but not limited to, the following supplementary notes.

### (Supplementary Note 1)

A crop growth assistance apparatus including: an accepting means for accepting a request containing any of a size, a taste, a harvest period, and a harvest yield of a crop which is a subject of growth; a generating means for generating response information containing a method for growing the crop which is the subject of growth, in accordance with the request and a learned model having learned relations between methods for growing a plurality of crops and growth results including any of sizes, tastes, harvest periods, and harvest yields of the plurality of crops; and an outputting means for outputting the method for growing the crop which is the subject of growth. This configuration provides an example advantage of making it possible to assist the growth of a crop.

### (Supplementary Note 2)

The crop growth assistance apparatus described in supplementary note 1, further including a basis generating means for generating basis information containing a previous instance which is similar to the method for growing the crop which is the subject of growth, the outputting means being configured to further output the basis information. This makes it possible for a user to refer to response information in light of the basis for the response information.

### (Supplementary Note 3)

The crop growth assistance apparatus described in supplementary note 1 or 2, in which the learned model is a grown graph which contains a plurality of nodes regarding a previously grown crop and links each indicating relationship between corresponding nodes of the plurality of nodes and which has learned the relationship between nodes of the plurality of nodes. This configuration provides an example advantage of making it possible to assist the growth of a crop.

### (Supplementary Note 4)

The crop growth assistance apparatus described in supplementary note 3, further including a link prediction means for predicting a node to be linked to a node contained in a to-be-grown graph containing a plurality of nodes regarding the subject of growth, from among nodes contained in the grown graph and related to tasks performed during growth of a previously grown crop, with use of the to-be-grown graph and the grown graph, through a link prediction for predicting relationship between nodes which are not connected together via a link in the to-be-grown graph and the grown graph, the generating means being configured to generate the response information according to the node predicted by the link prediction means. With this configuration, it is possible to provide information useful for a task to be performed on the subject of growth.

### (Supplementary Note 5)

The crop growth assistance apparatus described in supplementary note 4, in which the accepting means is configured to further accept an input of a condition regarding the grown graph, and the link prediction means is configured to predict a node to be linked to a node contained in the to-be-grown graph, from among nodes contained in the grown graph that satisfies the condition and related to tasks performed during growth of a previously grown crop. With this configuration, it is possible to predict a node as intended by a user.

### (Supplementary Note 6)

The crop growth assistance apparatus described in supplementary note 4, further including an evaluating means for evaluating a recommendation level of the node predicted by the link prediction means, in accordance with another node contained in the grown graph which includes the node predicted by the link prediction means. With this configuration, it is possible to contribute to the determination on a task promising for more preferable growth result.

### (Supplementary Note 7)

The crop growth assistance apparatus described in supplementary note 3, in which the accepting means is configured to further accept an input of at least one selected from the group consisting of details and a timing of a task to be performed on the subject of growth, the crop growth assistance apparatus further includes a link prediction means for calculating a probability that a node indicating a predetermined growth result is linked to a to-be-grown graph containing a node which indicates at least one selected from the group consisting of the details and the timing of the task inputted, with use of the to-be-grown graph and the grown graph, through a link prediction for predicting relationship between nodes which are not connected together via a link in the to-be-grown graph and the grown graph, and the generating means is configured to generate the response information in accordance with the probability calculated by the link prediction means. With this configuration, it is possible to predict, before performing a task which will be performed by the grower, whether a predetermined growth result is likely to be obtained through the task.

### (Supplementary Note 8)

The crop growth assistance apparatus described in supplementary note 3, in which the accepting means is configured to accept an input of a desired growth result in relation to the crop which is the subject of growth, the crop growth assistance apparatus further includes a link prediction means for predicting a node to be linked to a node contained in a to-be-grown graph containing a node which indicates the growth result inputted, from among nodes contained in the grown graph and related to tasks performed during growth of a previously grown crop, with use of the to-be-grown graph and the grown graph, through a link prediction for predicting relationship between nodes which are not connected together via a link in the to-be-grown graph and the grown graph, and the generating means is configured to generate the response information in accordance with the node calculated by the link prediction means. With this configuration, it is possible to provide material for determining a task necessary to obtain a desired growth result.

### (Supplementary Note 9)

The crop growth assistance apparatus described in supplementary note 3, further including a link prediction means for identifying a crop which has predetermined relationship with the subject of growth and which is included in a plurality of previously grown crops, with use of a to-be-grown graph containing a plurality of nodes regarding the subject of growth and a plurality of grown graphs which are generated individually for the plurality of previously grown crops and each of which is the grown graph, through a link prediction for predicting relationship between nodes which are not connected together via a link in the to-be-grown graph and the grown graph, and the generating means being configured to generate the response information regarding the crop identified by the link prediction means. With this configuration, it is possible to provide information useful for growing a crop.

### (Supplementary Note 10)

A crop growth assistance method including: a computer accepting a request containing any of a size, a taste, a harvest period, and a harvest yield of a crop which is a subject of growth; the computer generating response information containing a method for growing the crop which is the subject of growth, in accordance with the request and a learned model having learned relations between methods for growing a plurality of crops and growth results including any of sizes, tastes, harvest periods, and harvest yields of the plurality of crops; and the computer outputting the method for growing the crop which is the subject of growth. This configuration provides an example advantage of making it possible to assist the growth of a crop.

### (Supplementary Note 11)

A crop growth assistance program for causing a computer to carry out: a process of accepting a request containing any of a size, a taste, a harvest period, and a harvest yield of a crop which is a subject of growth; a process of generating response information containing a method for growing the crop which is the subject of growth, in accordance with the request and a learned model having learned relations between methods for growing a plurality of crops and growth results including any of sizes, tastes, harvest periods, and harvest yields of the plurality of crops; and a process of outputting the method for growing the crop which is the subject of growth. This configuration provides an example advantage of making it possible to assist the growth of a crop.

### [Additional Remark 3]

The whole or part of the example embodiments disclosed above can be further described as the following supplementary notes.

A crop growth assistance apparatus including: a process of accepting a request containing any of a size, a taste, a harvest period, and a harvest yield of a crop which is a subject of growth; a process of generating response information containing a method for growing the crop which is the subject of growth, in accordance with the request and a learned model having learned relations between methods for growing a plurality of crops and growth results including any of sizes, tastes, harvest periods, and harvest yields of the plurality of crops; and a process of outputting the method for growing the subject of growth.

It should be noted that this crop growth assistance apparatus may further include a memory, and the memory may have recorded thereon a program (crop growth assistance program) for causing a computer to carry out: a process of accepting a request containing any of a size, a taste, a harvest period, and a harvest yield of a crop which is a subject of growth; a process of generating response information containing a method for growing the crop which is the subject of growth, in accordance with the request and a learned model having learned relations between methods for growing a plurality of crops and growth results including any of sizes, tastes, harvest periods, and harvest yields of the plurality of crops; and a process of outputting the method for growing the subject of growth. In addition, this program may be recorded on a computer-readable, non-transitory, and tangible recording medium.

### REFERENCE SIGNS LIST

1: Crop growth assistance apparatus
11: Accepting section
12: Generating section
13: Outputting section
2: Crop growth assistance apparatus
201: Accepting section
204: Link prediction section
205: Evaluating section
206: Generating section
207: Basis generating section
208: Outputting section
3: Crop growth assistance apparatus
301: Accepting section
303: Link prediction section
304: Graph updating section
305: Generating section
306: Basis generating section
307: Outputting section
4: Crop growth assistance apparatus
401: Accepting section
403: Link prediction section
405: Generating section
406: Basis generating section
407: Outputting section
5: Crop growth assistance apparatus
501: Accepting section
502: Graph generating section
503: Link prediction section
504: Evaluating section
505: Generating section
506: Basis generating section

What is claimed is:

1. A crop growth assistance apparatus comprising:
at least one processor, the at least one processor carrying out:
an accepting process of accepting a request containing any of a size, a taste, a harvest period, and a harvest yield of a crop which is a subject of growth;
a generating process of generating response information containing a method for growing the crop which is the subject of growth, in accordance with the request and a learned model having learned relations between methods for growing a plurality of crops and growth results including any of sizes, tastes, harvest periods, and harvest yields of the plurality of crops; and
an outputting process of outputting the method for growing the crop which is the subject of growth.

2. The crop growth assistance apparatus according to claim 1, wherein
the at least one processor further carries out a basis generating process of generating basis information containing a previous instance which is similar to the method for growing the crop which is the subject of growth, and
in the outputting process, the at least one processor further outputs the basis information.

3. The crop growth assistance apparatus according to claim 1, wherein
the learned model is a grown graph which contains a plurality of nodes regarding a previously grown crop and links each indicating relationship between corresponding nodes of the plurality of nodes and which has learned the relationship between nodes of the plurality of nodes.

4. The crop growth assistance apparatus according to claim 3, wherein
the at least one processor further carries out a link prediction process of predicting a node to be linked to a node contained in a to-be-grown graph containing a plurality of nodes regarding the subject of growth, from among nodes contained in the grown graph and related to tasks performed during growth of a previously grown crop, with use of the to-be-grown graph and the grown graph, through a link prediction for predicting relationship between nodes which are not connected together via a link in the to-be-grown graph and the grown graph, and
in the generating process, the at least one processor generates the response information according to the node predicted in the link prediction process.

5. The crop growth assistance apparatus according to claim 4, wherein
in the accepting process, the at least one processor further accepts an input of a condition regarding the grown graph, and
in the link prediction process, the at least one processor predicts a node to be linked to a node contained in the to-be-grown graph, from among nodes contained in the grown graph that satisfies the condition and related to tasks performed during growth of a previously grown crop.

6. The crop growth assistance apparatus according to claim 4, wherein
the at least one processor further carries out an evaluating process of evaluating a recommendation level of the node predicted in the link prediction process, in accordance with another node contained in the grown graph which includes the node predicted in the link prediction process.

7. The crop growth assistance apparatus according to claim 3, wherein
in the accepting process, the at least one processor further accepts an input of at least selected from the group consisting of details and a timing of a task to be performed on the subject of growth,
the at least one processor further carries out a link prediction process of calculating a probability that a node indicating a predetermined growth result is linked to a to-be-grown graph containing a node which indicates at least one selected from the group consisting of the details and the timing of the task inputted, with use of the to-be-grown graph and the grown graph, through a link prediction for predicting relationship between nodes which are not connected together via a link in the to-be-grown graph and the grown graph, and
in the generating process, the at least one processor generates the response information in accordance with the probability calculated in the link prediction process.

8. The crop growth assistance apparatus according to claim 3, wherein
in the accepting process, the at least one processor accepts an input of a desired growth result in relation to the crop which is the subject of growth,
the at least one processor further carries out a link prediction process of predicting a node to be linked to a node contained in a to-be-grown graph containing a node which indicates the growth result inputted, from among nodes contained in the grown graph and related to tasks performed during growth of a previously grown crop, with use of the to-be-grown graph and the grown graph, through a link prediction for predicting relationship between nodes which are not connected together via a link in the to-be-grown graph and the grown graph, and
in the generating process, the at least one processor generates the response information in accordance with the node calculated in the link prediction process.

9. The crop growth assistance apparatus according to claim 3, wherein
the at least one processor further carries out a link prediction process of identifying a crop which has predetermined relationship with the subject of growth and which is included in a plurality of previously grown crops, with use of a to-be-grown graph containing a plurality of nodes regarding the subject of growth and a plurality of grown graphs which are generated individually for the plurality of previously grown crops and each of which is the grown graph, through a link prediction for predicting relationship between nodes which are not connected together via a link in the to-be-grown graph and the grown graph, and
in the generating process, the at least one processor generates the response information regarding the crop identified in the link prediction process.

10. A crop growth assistance method comprising:
a computer accepting a request containing any of a size, a taste, a harvest period, and a harvest yield of a crop which is a subject of growth;
the computer generating response information containing a method for growing the crop which is the subject of growth, in accordance with the request and a learned model having learned relations between methods for growing a plurality of crops and growth results including any of sizes, tastes, harvest periods, and harvest yields of the plurality of crops; and
the computer outputting the method for growing the crop which is the subject of growth.

11. A computer-readable non-transitory recording medium having recorded thereon a crop growth assistance program for causing a computer to function as a crop growth assistance apparatus, the program causing the computer to carry out:
a process of accepting a request containing any of a size, a taste, a harvest period, and a harvest yield of a crop which is a subject of growth;
a process of generating response information containing a method for growing the crop which is the subject of growth, in accordance with the request and a learned model having learned relations between methods for growing a plurality of crops and growth results including any of sizes, tastes, harvest periods, and harvest yields of the plurality of crops; and
a process of outputting the method for growing the crop which is the subject of growth.
